(19) United States
(12) Patent Application Publication
(10) Pub. No.: US 2025/0267071 A1
(43) Pub. Date: Aug. 21, 2025

(54) INTENT HANDLING

(71) Applicant: Telefonaktiebolaget LM Ericsson (publ), Stockholm (SE)

(72) Inventors: Ahmet Cihat BAKTIR, Küçükçekmece/Istanbul (TR); Dinand ROELAND, Sollentuna (SE); Elham Dehghan BIYAR, Istanbul (TR); Mirko D'ANGELO, Göteborg (SE); Jörg NIEMÖLLER, Sollentuna (SE); Ankita LIKHYANI, Bangalore (IN); Amadeu DO NASCIMENTO JUNIOR, Indaiatuba (BR); András ZAHEMSZKY, Sollentuna (SE); Marin ORLIC, Bromma (SE); Dagnachew Azene TEMESGENE, Johanneshov (SE)

(21) Appl. No.: 18/856,611

(22) PCT Filed: Apr. 14, 2022
(86) PCT No.: PCT/TR2022/050335

§ 371 Date: Oct. 12, 2024

(51) Int. Cl. H04L 41/14; H04L 41/16; H04L 43/16

(52) U.S. Cl. CPC H04L 41/145; H04L 41/16; H04L 43/16

(57) ABSTRACT

A method performed by a first node in a communications network for satisfying a first intent set for a system in the communications network, the first intent includes expectations, each expectation corresponding to a Key Performance Indicator, KPI, target. The method includes: predicting values of measurable properties that would be observed if a first action were performed in the system, using empirical relationships between actions and the measurable properties; calculating predicted KPI values that are predicted to be measured in the system if the first action were to be performed, from the predicted values of the measurable properties; and comparing the predicted KPI values to the KPI targets in the first intent to predict whether performing the first action would lead to the first intent being satisfied for the system.

### TECHNICAL FIELD

This disclosure relates to methods, nodes and systems in a communications network. More particularly but non-exclusively, the disclosure relates to intent handling in a communications network.

### BACKGROUND

In communications networks, intents are used to specify target operating conditions in the communications network. An intent may be described as the formal specification of expectations including requirements, goals, and constraints given to a technical system. Intents may be expressed in human-readable form. Example expectations that may be specified in an intent are: “At least 95% of the ultra-reliable low latency communications URLLC users shall experience a latency of maximum 20 msec”; “At least 80% of the users of the conversational video service shall have a minimum QoE (Quality of Experience) of 4.0”; or “Energy consumption of the system shall be kept to a minimum”. More detailed information on intents and how they relate to closed loops is described in the article “Intent-driven Closed Loops for Autonomous Networks” by Gomez et al. (2021) in the Journal of ICT Standardization, 2021: Vol 9 Iss 2; ISSN: 2246-0853 (Online Version).

An intent manager or intent handling function, provides a zero-touch control for an environment. The intent manager 100 illustrated in FIG. 1, is configured to act in accordance with (e.g. to implement) one or more intents received from an operator 102, and controls one or more environments 104. An environment is controlled by observing the environment (e.g. through sensors), reasoning 106 around the combination of the perceived situation and prior knowledge 108, and subsequently taking actions on the environment. Note that these steps together form a closed loop. The overall purpose of the intent manager is to perform actions to fulfill the intent(s). FIG. 1 is based on the paper by: Stuart J. Russel, Peter Norvig 2003: “Artificial Intelligence, A Modern Approach” (2013).

FIG. 2 shows an example internal architecture of an Intent manager. The intent manager described on a high level in FIG. 1 can be implemented in a cognitive framework (e.g. cognitive layer). The cognitive framework is further described in the article entitled: “Cognitive processes for adaptive intent-based networking” by Jörg Niemöller et al. Ericsson Technology Review; Nov. 11, 2020. FIG. 2 outlines an implementation in a cognitive framework. One or more intents are sent to the intent manager 100, e.g. by an operator 102. Each expectation in an intent becomes a Key Performance Indicator (KPI) that needs to be met. These are known as KPI targets. Raw data is exposed from the environment 104 and processed by data grounding agents 110. Data grounding agents can collect raw data that describes the state of the managed environment. This raw data is processed and stored in the knowledge base of the intent handler as properties. These properties are used to calculate the values of the measured KPIs. Target and measured KPIs can be compared, and the difference becomes an “issue” or goal that the intent manager needs to meet. For example, if the target KPI is “max 20 ms latency” but the measured KPI is “30 ms latency”, then the issue is to reduce the latency by at least 10 ms. One or more proposal agents 112 are responsible for proposing actions to solve the issues. Evaluation agents 114 make an assessment of which of the proposed actions are most likely to be successful and which should therefore be performed. Actuator agents 116 then execute the selected action on the environment 104 under control.

In the context of a communications network, the environment 104 under control is the communications network itself, or a system therein, and the operator 102 may be a (human) network operator, or other intent handling function. Note that, for scalability reasons, a communications network is typically divided into multiple domains (e.g, there may be more than one environment). Furthermore, intent managers may come in a hierarchy, thus the environment under control could be a part of the mobile network or could be another intent manager. The operator could be (a portal to) the human network operator, or another intent manager.

A more detailed description of intents and the architecture around intents can be found in TM Forum specifications such as “TM Forum Introductory Guide: Autonomous Networks-Technical Architecture” (IG1230) and “TM Forum Introductory Guide: Intent in Autonomous Networks” (IG1253). These specifications also describe intent managers and the envisioned hierarchy of intent managers.

### SUMMARY

In a real communications network, multiple intents may be sent to a single intent manager, each with multiple expectations and multiple corresponding KPI targets. All of these KPI targets need to be fulfilled. When a certain KPI target is not fulfilled, a proposal agent may assess the situation and propose an action that would solve the issue. However, that action may have negative side effects on one or more of the other KPIs. Thus, meeting one KPI target can lead to degradation of other KPIs. This leads to conflict. It is an object of embodiments herein to address some of these issues.

Thus, according to a first aspect there is a method performed by a first node in a communications network for satisfying a first intent set for a system in the communications network, the first intent comprises expectations, each expectation corresponding to a Key Performance Indicator, KPI, target. The method comprises: i) predicting values of measurable properties that would be observed if a first action were performed in the system, using empirical relationships between actions and the measurable properties; ii) calculating predicted KPI values that are predicted to be measured in the system if the first action were to be performed, from the predicted values of the measurable properties; and iii) comparing the predicted KPI values to the KPI targets in the first intent to predict whether performing the first action would lead to the first intent being satisfied for the system.

According to a second aspect there is a method performed by a second node in a communications network for satisfying a first intent set for a system in the communications network, wherein the first intent comprises expectations, each expectation corresponding to a Key Performance Indicator, KPI, target. The method comprises: sending a message to a first node in the communications network, wherein the first node acts as an intent manager for the communications network; and wherein the message comprises the first intent for the system and one or more penalties to be applied if the expectations in the first intent are not satisfied.

According to a third aspect there is a first node in a communications network for satisfying a first intent set for a system in the communications network, wherein the first intent comprises expectations, each expectation corresponding to a Key Performance Indicator, KPI, target. The first node comprises: a memory comprising instruction data representing a set of instructions; and a processor configured to communicate with the memory and to execute the set of instructions. The set of instructions, when executed by the processor, cause the processor to: i) predict values of measurable properties that would be observed if a first action were performed in the system, using empirical relationships between actions and the measurable properties; ii) calculate predicted KPI values that are predicted to be measured in the system if the first action were to be performed from the predicted values of the measurable properties; and iii) compare the predicted KPI values to the KPI targets in the first intent to predict whether performing the first action would lead to the first intent being satisfied for the system.

According to a fourth aspect there is a first node in a communications network wherein the first node is configured to: i) predict values of measurable properties that would be observed if a first action were performed in the system, using empirical relationships between actions and the measurable properties; ii) calculate predicted KPI values that are predicted to be measured in the system if the first action were to be performed from the predicted values of the measurable properties; and iii) compare the predicted KPI values to the KPI targets in the first intent to predict whether performing the first action would lead to the first intent being satisfied for the system.

According to a fifth aspect there is a second node in a communications network for satisfying a first intent set for a system in the communications network, wherein the first intent comprises expectations, each expectation corresponding to a Key Performance Indicator, KPI, target. The second node comprises: a memory comprising instruction data representing a set of instructions; and a processor configured to communicate with the memory and to execute the set of instructions. The set of instructions, when executed by the processor, cause the processor to: send a message to a first node in the communications network, wherein the first node acts as an intent manager for the communications network. The message comprises the first intent for the system and one or more penalties to be applied if the expectations in the first intent are not satisfied.

According to a sixth aspect there is a second node in a communications network wherein the second node is configured to: send a message to a first node in the communications network, wherein the first node acts as an intent manager for the communications network. The message comprises the first intent for the system and one or more penalties to be applied if the expectations in the first intent are not satisfied.

According to a seventh aspect there is a computer program comprising instructions which, when executed on at least one processor, cause the at least one processor to carry out a method according to the first aspect or the second aspect.

According to an eight aspect there is a carrier containing a computer program according to the seventh aspect, wherein the carrier comprises one of an electronic signal, optical signal, radio signal or computer readable storage medium.

According to a ninth aspect there is a computer program product comprising non transitory computer readable media having stored thereon a computer program according to the seventh aspect.

Thus, the methods herein provide methods for predicting the effect of a proposed action on other KPIs in the system through the use of empirical relationships. This provides a technical solution that can be used to determine (and solve) run-time detection of conflicts between multiple KPIs. The main advantage of the detecting conflicts is having a higher degree of intents satisfied in the system. Other technical advantages relate to the performance of the network: by determining conflicts we can approve actions that do not destabilize the network, hence, stability and efficient resource utilization are improved. This leads to improved Operator satisfaction, as well as improved service for end-users. Furthermore, the disclosure herein provides a penalty-based mechanism that can be used to determine which action from a plurality of proposed actions should be chosen in situations where there are conflicting KPI targets (particularly where potentially not all of the KPI targets can be met at the same time).

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a zero-touch intent handling mechanism in a communications network (Prior Art);

FIG. 2 shows an intent handling function (e.g. Intent manager) in a communications network (Prior Art);

FIG. 3 shows a first node in a communications network according to some embodiments herein;

FIG. 4 shows a method in a first node according to some embodiments herein;

FIG. 5 illustrates an example environment in a communications network;

FIG. 6 illustrates example APIs in a communications network;

FIG. 7 illustrates example measurable properties that can be made available from an example network deployment;

FIG. 8 shows an example configuration of an intent handling function according to some embodiments herein;

FIG. 9 shows another example configuration of an intent handling function according to some embodiments herein;

FIG. 10 shows an example probability density function;

FIG. 11 shows an example method in a second node according to some embodiments herein;

FIG. 12 shows an example modified intent common model according to some embodiments herein;

FIG. 13 shows an example signal diagram according to some embodiments herein;

FIG. 14 shows an example modified intent common model according to some embodiments herein;

FIG. 15 shows an example signal diagram according to some embodiments herein;

FIG. 16 shows an example method according to some embodiments herein; and

FIG. 17 shows a further example method according to some embodiments herein.

### DETAILED DESCRIPTION

As noted above, many intents may be managed by a single intent manager. When a certain KPI target is not fulfilled, a proposal agent 112 may assess the situation and propose an action to solve the issue. However, that action may have negative side effects on one or more of the other KPIs. As an example: assume that there are two KPI targets set for a system (which may come from the same intent, or from two intents). The first KPI target is a maximum latency for URLLC users. The second KPI target is a minimum Quality of Experience (QoE) for conversational video users. Assume there is an issue with the measured latency KPI. The proposed action may be to increase the priority of the user plane packets for all URLLC users. However, the users of the conversational video share the same network (that is, the same environment under control). Because of the action, the QoE KPI may deteriorate, possibly below its target value. In other words, solving one issue could create another issue. It is an object of embodiments herein to avoid or mitigate negative side effects of an action.

In general, there are three ways to address KPI target conflict:
A first way is to ensure that negative side effects cannot happen. This can be done by designing the system such that KPIs don't interfere. This may put requirements on how the environment under control is designed and dimensioned (for example, place video users in one network slice, URLLC users in another network slice). It may also put requirements on how the intents are formulated (for example, simply don't allow the intents to express expectations to this detail). This approach is possible, but becomes restrictive. It also puts the burden on the designer to be aware of all relations between KPIs.
A second way to avoid negative side effects is to detect them at deployment time. For example by analyzing the feasibility of each new intent. When a new intent is received, for example the intent holding the expectation for the QoE, the intent manager would check if these new expectations may interfere with already existing expectations. If the latency expectation was already there, the intent manager would detect a potential interference and reject the new intent. The detection of possible interference can be based on a model of the environment under control, a model of all possible actions that may be taken for the new expectations, and a model of the results of these actions. These could then be correlated to possible actions for existing expectations. If there is an overlap, there is a risk that interference may happen. In that case the new intent is rejected. This approach is possible, but with the disadvantage that it rejects too many intents. Even though there is a potential interference, it cannot be known at deployment time if this interference really will happen at run-time.
A third way to avoid negative side effects is to detect conflicts at run-time and to solve the situation as (or before) it happens.

The embodiments in this disclosure focus on the third way. It should be noted that the three alternatives noted above are not mutually exclusive. A system may, for example, partly implement the first and second options to avoid the most obvious conflicts and use the third option for optimization.

The solutions described herein for detecting conflicts generally comprise two steps:
Predict the impact of a certain action on the state of the environment under control. In other words: suppose a certain action is taken on the environment, how will the results of that action show in the raw data?
Predict how the new state of the environment under control impacts all KPIs in the intent manager. In other words: given the effect of the action to the raw data (previous step), how will that change the KPIs?

As described in more detail below, the steps above may generally be performed using machine reasoning rules. Thus, in this way, conflicts can be identified upfront, before an action is taken and this information can be used to select the most appropriate action in response to an issue.

In more detail, the disclosure herein relates to a communications network (or telecommunications network). A communications network may comprise any one, or any combination of: a wired link (e.g. ADSL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

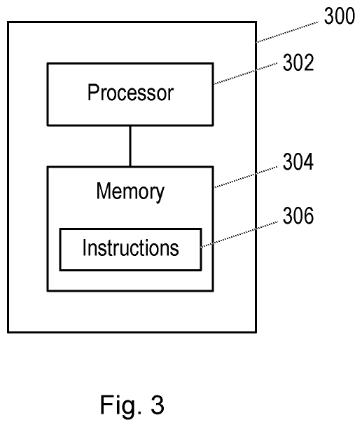

FIG. 3 illustrates a network node 300 in a communications network according to some embodiments herein. Generally, the node 300 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 300 may be an Intent Manager, or Intent Handling Function. The node 300 may be embedded in a cognitive layer of the communications network.

The node 300 is configured (e.g. adapted, operative, or programmed) to perform any of the embodiments of the method 400 as described below. It will be appreciated that the node 300 may comprise one or more virtual machines running different software and/or processes. The node 300 may therefore comprise one or more servers, switches and/or storage devices and/or may comprise cloud computing infrastructure or infrastructure configured to perform in a distributed manner, that runs the software and/or processes.

The node 300 may comprise a processor (e.g. processing circuitry or logic) 302. The processor 302 may control the operation of the node 300 in the manner described herein. The processor 302 can comprise one or more processors, processing units, multi-core processors or modules that are configured or programmed to control the node 300 in the manner described herein. In particular implementations, the processor 302 can comprise a plurality of software and/or hardware modules that are each configured to perform, or are for performing, individual or multiple steps of the functionality of the node 300 as described herein.

The node 300 may comprise a memory 304. In some embodiments, the memory 304 of the node 300 can be configured to store program code or instructions 306 that can be executed by the processor 302 of the node 300 to perform the functionality described herein. Alternatively or in addition, the memory 304 of the node 300, can be configured to store any requests, resources, information, data, signals, or similar that are described herein. The processor 302 of the node 300 may be configured to control the memory 304 of the node 300 to store any requests, resources, information, data, signals, or similar that are described herein.

It will be appreciated that the node 300 may comprise other components in addition or alternatively to those indicated in FIG. 3. For example, in some embodiments, the node 300 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 302 of node 300 may be configured to control such a communications interface to transmit to and/or receive from other nodes or network functions requests, resources, information, data, signals, or similar.

The node 300 may be configured for satisfying a first intent set for a system in the communications network, wherein the first intent comprises expectations, each expectation corresponding to a Key Performance Indicator (KPI) target. Briefly, the node 300 may be configured to: i) predict values of measurable properties that would be observed if a first action were performed in the system, using empirical relationships between actions and the measurable properties; ii) calculate predicted KPI values that are predicted to be measured in the system if the first action were to be performed from the predicted values of the measurable properties; and iii) compare the predicted KPI values to the KPI targets in the first intent to predict whether performing the first action would lead to the first intent being satisfied for the system.

An intent may be described as a specification for a technical system. An intent comprises a plurality of expectations. Each expectation may set a requirement, goal, or constraint for the technical system. See TeleManagement (TM) Forum documentation IG1253.

The expectations in an intent may be expressed in human readable form. Some example expectations are:
“At least 95% of the URLLC users shall experience a latency of maximum 20 msec”,
“At least 80% of the users of the conversational video service shall have a minimum QoE (Quality of Experience) of 4.0”, and
“Energy consumption of the system shall be kept to a minimum”.

Thus an expectation may indicate a threshold value, threshold range, or criteria (min/max) that is required of a particular measurable property in the system.

Expectations correspond to KPI targets. In other words, expectations can be mapped or converted into KPIs targets. As an example, a human-readable expectation may be converted into one or more measurable criteria in the communications network. A KPI target may indicate a threshold value, threshold range, or criteria (min/max) that is required of a particular measurable property in the system.

As noted in the background section, intents and the architecture around intents are described in more detail in TM Forum specifications such as “TM Forum Introductory Guide: Autonomous Networks-Technical Architecture” (IG1230) and “TM Forum Introductory Guide: Intent in Autonomous Networks” (IG1253). See also the aforementioned article: “Intent-driven Closed Loops for Autonomous Networks” by Gomez et al. (2021) in the Journal of ICT Standardization, 2021: Vol 9 Iss 2; ISSN: 2246-0853 (Online Version).

The node 300 is configured to perform processes to satisfy a first intent set for a system. The node 300 may be configured to perform processes to satisfy a plurality of intents for the system. As noted above, some of the intents in the plurality of intents may be conflicting (e.g. satisfying a first intent may lead to degradation of measured KPIs relating to a second intent).

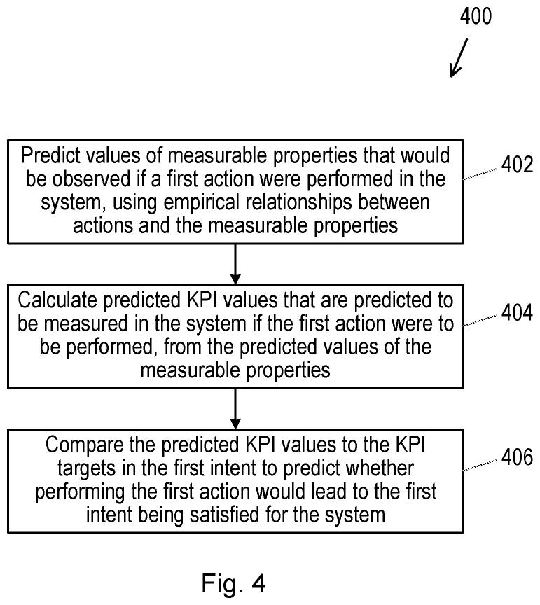

As noted above, the node 300 is configured to perform the method 400 shown in FIG. 4. In brief, in a first step 402, the method 400 comprises predicting values of measurable properties that would be observed if a first action were performed in the system, using empirical relationships between actions and the measurable properties. In a second step 404, the method comprises: calculating predicted KPI values that are predicted to be measured in the system if the first action were to be performed from the predicted values of the measurable properties. In a third step 406 the method comprises comparing the predicted KPI values to the KPI targets in the first intent to predict whether performing the first action would lead to the first intent being satisfied for the system.

The system may comprise part of the communications network, such as a domain in the communications network. For example, the part of the communications network that is under the control of an intent manager performing the method 400. As noted above, the communications network may be partitioned, in such an embodiment, the system under control may comprise one or more partitions in the communications network.

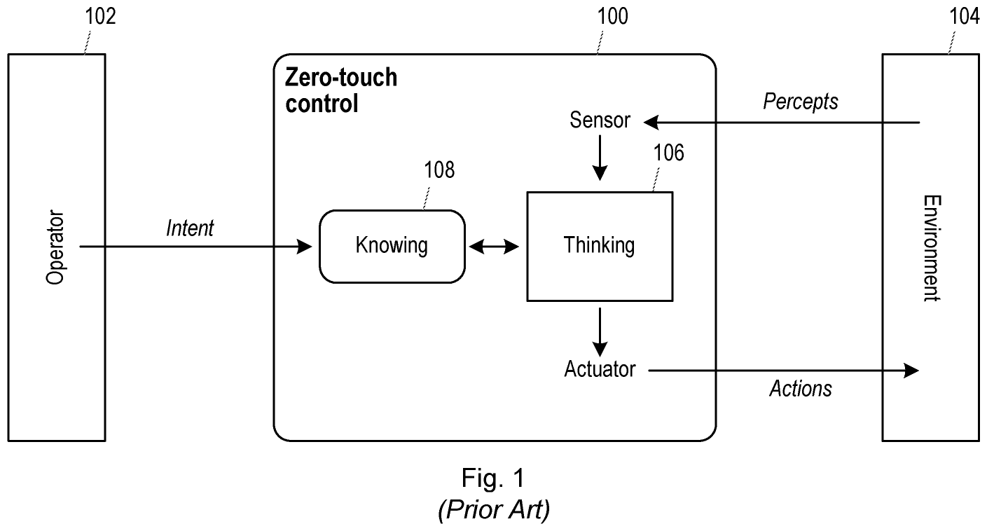

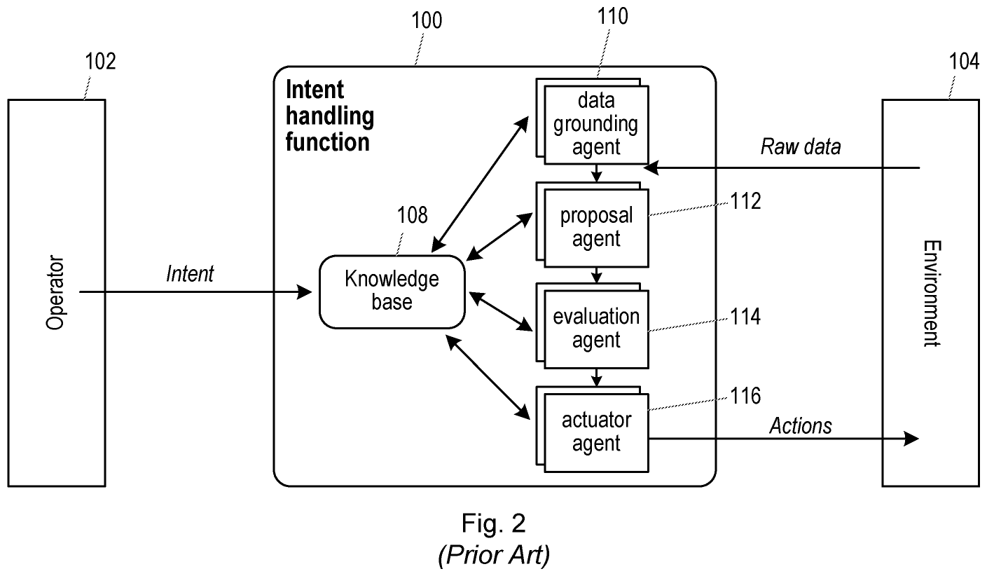

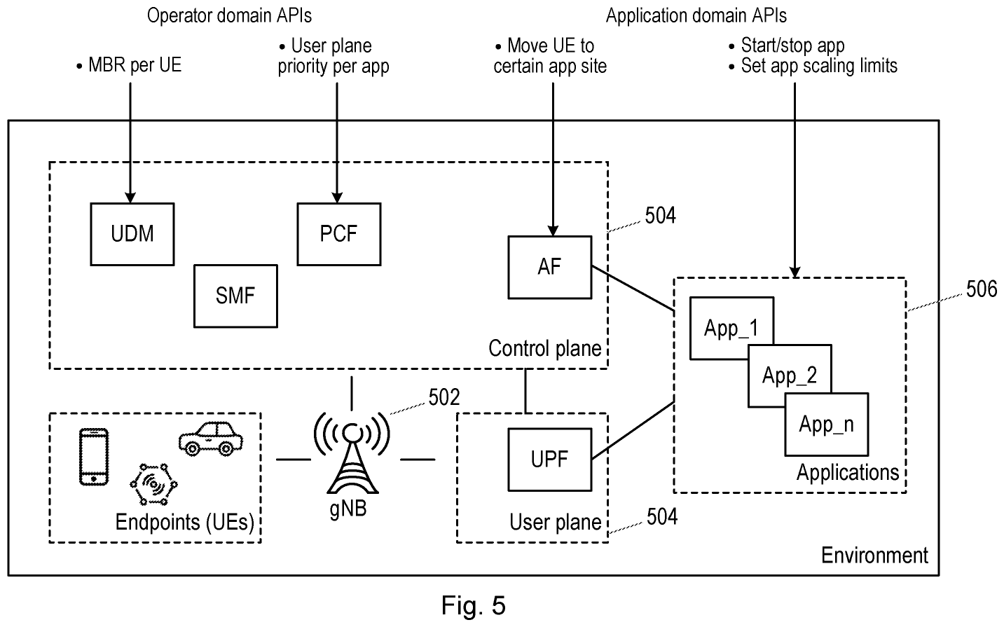

The environment 104 under control (c.f. FIG. 1 and FIG. 2) refers to all observable properties in the system. FIG. 5 shows an example of a system in a communications network. The system contains a radio access network (gNBs 502), a core network 504 (User Plane Functions (UPFs), Policy Control Function (PCF), Session Management Function (SMF), Application Function (AF); e.g. the Control Plane and User Plane in FIG. 5) and applications 506. Note that these functions may each be spread across multiple physical sites. For example, there may be more than one UPF instance, and each may be located at a different site. Similarly, the applications may come in multiple instances spread across local edge sites (close to the UPF) or national central sites.

FIG. 5 also shows examples of actions that can be taken on the network. These actions are examples of the actions that actuator agents (116 in FIG. 2) can take on the environment 104 under control.

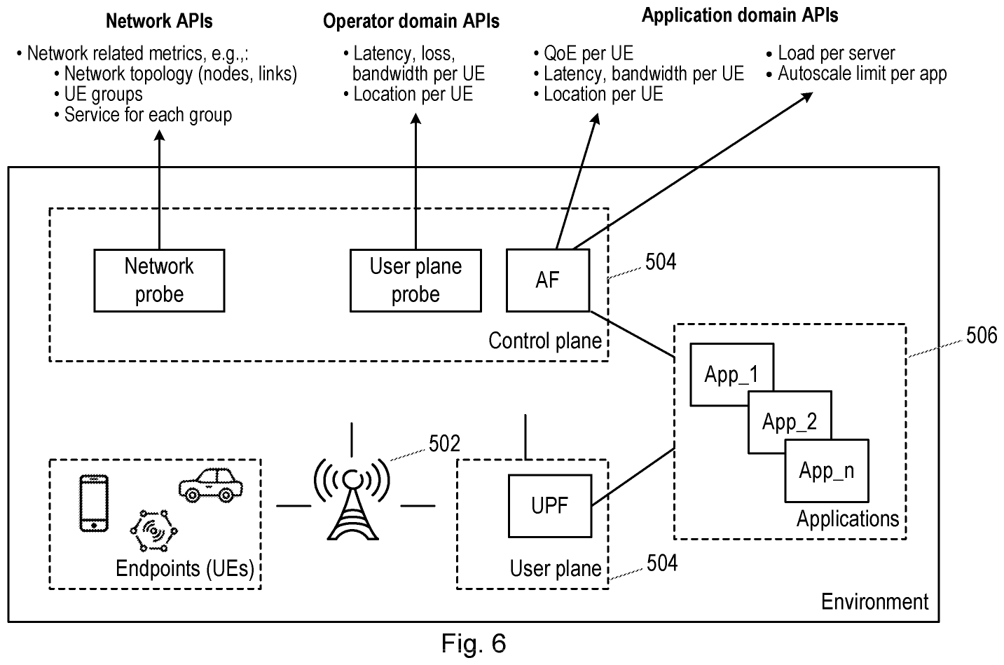

The measurable properties include any property that can be measured in the system, for example, any network state information. FIG. 6 shows the same example system as in FIG. 5, but now with the APIs that can be used to extract network state information. This would be the raw data that data grounding agents can monitor from the environment under control (c.f. FIG. 2). Using these APIs, the data grounding agents can collect information (i.e., raw data) that describes the state of the environment under control. This raw data is processed and stored in the knowledge base of the intent manager (see FIG. 2) as properties.

An example of raw data processing is the following: A user plane probe may collect latency measurement per UE (for scalability, this would typically not be all UEs but a representative subset of all UEs). The latency measurement may, for example, be exposed via the API as raw data items every 4 seconds. The data grounding agent using the API may process the raw data and calculate the average latency per UE over the last minute. It is the average latency per UE that is stored as property in the knowledge base.

Various types of properties may be stored. As an example, for the system illustrated in FIGS. 5 and 6, the measurable properties may be those listed in Appendix I. The middle column states the name of the data grounding agent that would store the property in the knowledge base. In general, measurable properties come in three types:
Static properties that do not change. They typically relate to the infrastructure. This means they will not change upon an action either, so for these properties there is no need to predict any change due to an action.
Dynamic properties are typically related to application traffic. They change continuously depending on the application and the load situation of the network and the data centre where the network function run. These properties are typically subject for prediction when an action is taken.
Configurable properties may change, but the change is typically not dependent on traffic or load situations. The change may instead come due to a configuration action: add or remove an intent, change the UE's user plane priority, change the UE's MBR (Maximum Bit Rate), etc. “Prediction” of these properties is easy when the configuration action tells how the property will change.

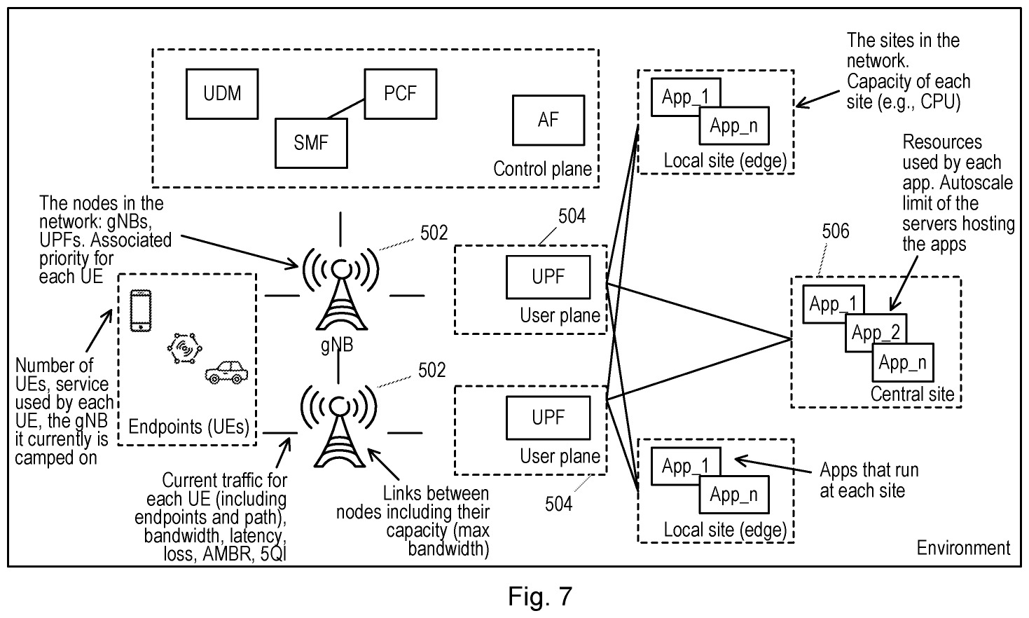

FIG. 7 shows an example of the measurable properties that can be made available from an example network deployment with three application sites and two user plane sites (a local application site would typically be the same a user plane site, so in total there would be three sites here).

Turning back now to step 402 of the method 400 which comprises predicting values of measurable properties that would be observed if a first action were performed in the system, using empirical relationships between actions and the measurable properties.

This step involves predicting the impact of a given action on the measurable properties of the environment under control (that is, the system in the communications network). This can be performed by logical inference rules or by specialized agents (for example, implemented via machine learning algorithms).

Generally, the empirical relationships may be based on machine reasoning rules, such as logical inference rules. In some embodiments, the empirical relationships may be based on symbolic reasoning. The symbolic reasoning is deductive where a conclusion is established by means of premises according to logical inference rules.

The empirical relationships may be previously known (or previously obtained) relationships. They may be obtained via experimentation, for example, the empirical relationships may comprise one or more mathematical formulae derived from experimental data. Experimental data may comprise (first) test actions and resulting (first) test values of the measurable properties as performed on the system. In other words, experiments may be performed on the (real or live) system and the effects on the measurable properties may be quantified and used to derive empirical relationships between the actions and measurable properties.

In other embodiments, experimental data may comprise (second) test actions and resulting (second) test values of the measurable properties as determined using a digital twin of the system. In other words, a digital twin may be created for the system and experiments may be performed on the digital twin and the effects on the measurable properties may be quantified and used to derive empirical relationships between the actions and measurable properties in the real system.

The skilled person will be familiar with digital twins and methods for creating and using digital twins of a system. The application of digital twins in communications networks is described, for example, in the Ericsson Blog article by Peter Öhlén entitled, “The future of digital twins: what will they mean for mobile networks?”. See also paper by: Latif U. Khan et al. (2022) entitled: “Digital Twin of Wireless Systems: Overview, Taxonomy, Challenges, and Opportunities”.

In some embodiments, the empirical relationships may be encompassed in, or derived using machine learning. For example, logical inference rules may be deduced using machine learning.

As an example, a machine learning model may be used to predict values of the measurable properties that would result from an action, using a training data set comprising training examples, each example comprising: starting values of the measurable properties (e.g. before the actin is performed), an example action and values of the measurable properties resulting from the example action (e.g. ground truth values of the measurable properties after the action was performed). The training dataset may have been trained using the experimental data described above e.g. either real data obtained from tests performed on the system, or synthetic data obtained from tests performed on a digital twin, or any other data set comprising example actions and resulting values of the measurable properties.

In some embodiments, the empirical relationships comprise correlations between actions and the measurable properties. Such empirical relationships may have been derived using symbolic reasoning, or derived from existing knowledge using measurements and observations in combination with inference rules. In other words, the empirical relationships may have been derived based on the experience of human engineers. As noted above, the empirical relationships may be expressed as logical inference rules, e.g. as a sequence of if-then statements.

The empirical relationships may thus be used to map current values of the measurable properties to predicted values of the measurable properties, if the first action were to be performed.

Turning now to step 404, the method then comprises: calculating predicted KPI values that are predicted to be measured in the system if the first action were to be performed, from the predicted values of the measurable properties. This step may comprise predicting KPI values of all KPIs in a system. In other words, step 404 involves calculating the impact (of the first action) on each KPI, given the predicted values of the measurable properties (that were predicted in step 402).

Generally, the predicted values of the measurable properties may be converted into predicted KPI values in the same manner in which measured values of the measurable properties are converted into measured KPIs in the live system. This may be performed, for example, using logical inference rules. Thus, step 404 leverages the intent manager's logical inference rules that are able to calculate the impact on KPIs of the measurable properties of the network.

In step 406, as noted above, the method 400 then comprises comparing the predicted KPI values to the KPI targets in the first intent to predict whether performing the first action would lead to the first intent being satisfied for the system. E.g. determining whether the intent would be met if the first action were performed.

The method 400 may be used to select an action from a plurality of actions to perform in order to satisfy the intent. For example, steps 402, 404 and 406 of the method 400 may be repeated for a second action. The method may then comprise selecting an action from the first action and the second action to perform in the system in order to satisfy the first intent, using the predicted KPI values for the first action and the predicted KPI values for the second action. The method 400 may then further comprise causing the selected action to be performed. This may comprise e.g. the intent manager 100 performing the selected action (e.g. directly), or sending a message to another node in the communications network to cause the other node to perform the selected action. Thus, the method 400 may be used to effect change in the system in order to meet the first intent. It will be appreciated that the examples above may be generalised to more than one intent, and to select an action from a plurality of actions.

Steps 402, 404 and 406 of the method 400 may be performed in response to a difference being determined between measured KPI values in the system and the KPI targets corresponding to the expectations in the first intent, and said difference being raised as an issue in the system. In this way, the method 400 may be used to resolve issues raised in the system. As such, the first and second actions described above may be first and second proposals for resolving said issue. For example the first and second actions may be different proposals to solve the issue in the system, proposed by a proposal agent 112.

In other embodiments, the method 400 may be used to resolve conflicts between intents. For example, the method 400 may further comprise determining that the predicted KPI values for the first action lead to a conflict with a second intent, if the predicted KPI values for the first action would lead to the second intent (e.g. (KPI targets associated with the second intent) not being satisfied.

As another example, the method 400 may further comprise determining that the predicted KPI values for the first action lead to a conflict between a first expectation and a second expectation in the first intent, if the predicted KPI values for the first would cause a second issue with the second expectation due to the second expectation not being satisfied. For example, due to the first action causing degradation of KPI values associated with KPI targets for the second expectation.

In other words, the method 400 may be used to determine conflicts between different intents, as well as conflicts between expectations in the same intent.

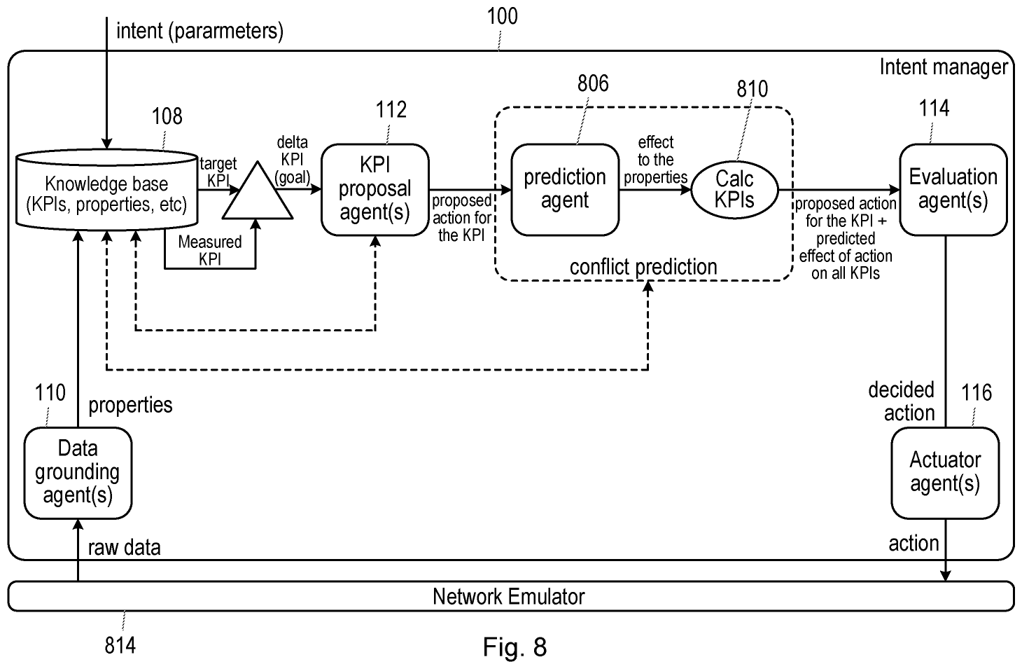

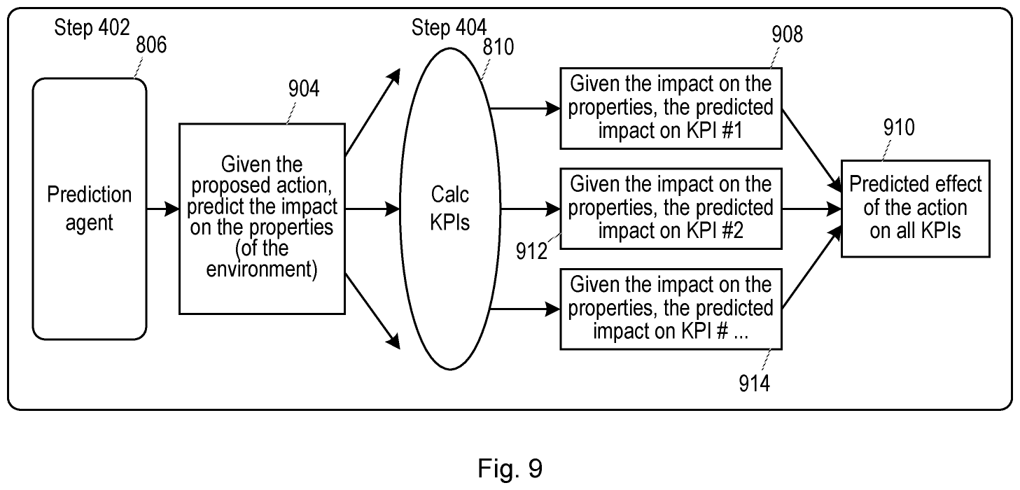

Turning now to an example, FIG. 8 illustrates an example Intent Manager 100 architecture that can be used for conflict prediction and resolution according to some embodiments herein. FIG. 8 illustrates the internal setup of an intent manager 100 (c.f. FIG. 2) that has been modified according to embodiments herein with conflict prediction functionality (illustrated as the dashed box comprising prediction agent 806 in FIG. 8) for performing steps 402 and 404 described above). The knowledge base 108 holds the KPI targets (extracted from the expectations in the intent), the measured KPIs (an abstraction of the properties stored by the data grounding agents) and the network state (all the properties in Appendix I). This information is extracted, e.g. using data grounding agents 110. Prediction agent 806 performs step 402 of the method 400 described above, and step 404 is performed by block 810, as illustrated in FIG. 9. The data grounding agents may take input either from the real environment, or as illustrated in FIG. 8 a network emulator 814.

FIG. 9 further illustrates the functionality of blocks 806 and 810. The Prediction agent 806 predicts 904 the impact of a proposed action on the measurable properties (of the environment). Block 810 then predicts the impact on KPIs 1-N (910, 912 . . . 914) in the system in order to predict the effect of the actions on all KPIs in the system 910. This can be used to determine and solve issues and conflicts in run-time.

Appendix II shows a table with example KPIs. In this example there are KPIs for three services: conversational video, URLLC and mIoT. For each of these services that is only one instance active. Each KPI description corresponds to an expectation in an intent. All measured and target KPIs happen to be in percentages in this example but could just as well have been in another unit.

One purpose of steps 402 and 404 is to give an assessment of the impact of a given action on more than one KPI; e.g. not only on the KPI that currently has an issue and for which an action was proposed to solve that issue. The assessment may come in the form of a numerical value (for example, the URLLC latency KPI is expected to become “100%” in the rightmost column of the table of Appendix II) but may also be less granular (for example, the URLLC latency KPI is expected to “increase”). The prediction may come with a confidence (for example, the chance that this prediction will happen is 70% in the last column in Appendix II). Sometimes all these properties can be predicted, sometimes not all. The assessment may also come in other formats as the one shown above.

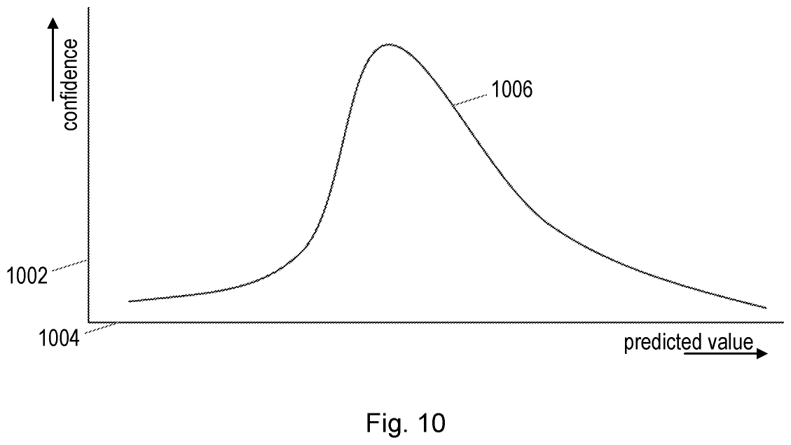

For example, the assessment may be formatted as a graph, such as the probability density function illustrated in FIG. 10 where the x-axis 1004 represents the predicted value and the y-axis 1002 the confidence of the prediction. In such a graphical representation the prediction would typically become a curve 1006 where the peak of the curve represents the highest confidence.

Turning now to an example, consider a scenario where an issue (e.g. problem) with the Quality of Experience (QoE) of the conversational video service is raised. The KPI target is that 90% of the users shall have at least 4.0. Currently, 0% of the users has at least 4.0. Now a proposal agent 112 has proposed a first action to improve the user plane packet priority for the users of the conversational video service instance. The first action proposed here is “change the user plane priority of users { . . . } from X to Y”, where “ . . . ” is a group of User Equipments (UEs).

The method 400 is then performed. In step 402 of the method 400, the impact on measurable properties as a result of the first action is predicted. All of the available measurable properties, or a subset of them may be used. Note that there is no need to assess impact on properties that are static. For example, network topology data is static in the example illustrated in Appendix II (even though in a real system the topology may change over time).

In this example, the table in Appendix III is then constructed. These are all the non-static properties from the environment under control (the example network system) described above in FIGS. 6 and Appendix I). The middle column indicates the chance that the property value is impacted by the given action. By default, each cell in that column is set of 0% (that is, no impact expected). The right column holds the current value of each property.

Some of the measurable property values in Appendix III will change if the first action is performed. The predicted new values are added to the table in Appendix III in a new column. In this example, step 402 (e.g. the prediction/estimation of the measurable parameter values) is performed using logical inference rules. Given the property classification table in Appendix I, the prediction of configurable and dynamic properties can be distinguished between:

### Prediction of Configurable Properties

The impact on configurable properties can be derived from the first action. As example, consider the proposed first action “change priority of users {UE11, UE12} from X to Y”. The table in Appendix III shows only the configurable properties, the dynamic properties are denoted with “ . . . ”. Within the configurable properties, only the “user plane priority” property for UE11 and UE12 will change due to the given action.

### Prediction of Dynamic Properties

What remains is the prediction of dynamic properties. This includes the prediction of dynamic properties for the UEs directly involved in the action (UE11 and UE12 in the example), but also the prediction of dynamic properties for all other UEs.

The overall idea is that there are correlations between the action and dynamic properties, and that these correlations can be captured in logical inference rules. Writing these rules could be done by a human expert or could be automated with for example machine learning. The underlying assumption is that the APIs towards the environment (e.g. as illustrated in FIGS. 5 & 6) do not change very frequently. It may also be assumed that—if a human designs the logical inference rules—the number of APIs is manageable for a human. If this is not the case, and the number of API is very large, then the environment can be split into multiple domains where each domain is controlled by a separate intent manager, or other automated methods may be used, such as machine learning.

Now going to the example network: Suppose that a human expert knows by experience that changing the priority of the traffic of some users only impacts other users that share the same transport link(s). Other users that do not share a transport link will not be impacted at all. Focussing on the transports link(s) where priorities may change: if the human expert knows how the underlying infrastructure divides the resources given the priorities, then the resource share each user currently has can be calculated, as well as the resource share each user will get if the action of changing the priorities would be taken. In other words, based on logical inference rules, the dynamic property “bandwidth” can be calculated (e.g. predicted) for all users before and after taking the action of changing the priority of some users. This is illustrated in the pseudo-code below.

As an intermediate result, the prediction agent 806 now knows the predicted dynamic property of bandwidth for all users. The human expert may further know by experience that there is a correlation between bandwidth and, for example, QoE. Such correlation can be measured in an experiment; for example, 1 Mbps gives QoE x, 2 Mbps gives QoE y, etc. In this plot of measurements, a fitted curve can be drawn, and this curve can be captured in a formula. As a result, there is a formula QoE=f(bandwidth). Such function can be coded as a logical inference rule. The pseudo code below shows an example comprising such formulas for the correlation bandwidth-QoE, and also for bandwidth-latency and bandwidth-loss.

Logical inference rules are uploaded to the cognitive framework or, alternatively, implemented in (logical inference rules that invoke) separate prediction agents. Uploading may be done when the actuator agent for this action is registered to the system. This way, the logical inference rules that predict the impact of the action tie to the agent performing the action.

Alternatively, the rules are uploaded to the knowledge base by a prediction agent 806. Either way, the rules are independent of the KPIs active in the system, and the number of empirical relationships (e.g. “rules”) for step 402 is proportional to the number of available actions (that is, the complexity is linear with the number of actions). This setup keeps the overall solution scalable and manageable.

### Pseudo-Code for the Prediction Agent of Action “Change User Plane Priority”

# Pseudo-code for predicting dynamic properties

```
For each UEₓ in the system do:
  Calculate the transport path for UEₓ
For each UEₓ in the system do:
  For each transport segment S of the transport path for UEₓ do:
    Get the group G of UEs that have S in their transport path
    If none of the UEs listed in the action is in G, then continue to the next iteration of the for loop
    Get the T_{CAPACITY}, the throughput capacity of S
    Get current throughput and current MBR of all UEs active on S
    If UEₓ has no current throughput property, then continue to the next iteration of the for loop
    Get the current, and if available the new, user plane priority of all UEs active on S
    If segment is of type “air link”:
      B_{ESTIMATE} = UEₓ.predictedUsedShare# see pseudocode for predicting bandwidth Error! Reference
        source not found.
          Else:
      # Other segments may have a different formula.
      # For now, skip this and fill in MBR as default
      B_{ESTIMATE} = UEx.predictedMBR # see pseudocode for predicting bandwidth
    If UEₓ's bandwidth estimated new value table cell is still empty, then fill in B_{ESTIMATE},
            otherwise fill in the minimum of the cell's current value and B_{ESTIMATE}
    If UEx's bandwidth estimated new value table cell's value has changed,
            update the chance in the same row accordingly
  If UEx's bandwidth estimated new value table cell is empty,
            then continue to the next iteration of the for loop
  If UEx is a mIoT UE:
    Get the current latency of UEx. If that property is available:
      Estimated latency = current latency + ( (current bandwidth − estimated bandwidth) /
            (current bandwidth) ) * current latency
      In the same row of the table, fill in the chance.
  If UEx is a URLLC UE:
    Get the current latency of UEx. If that property is available:
      graphCurrentLatency = e \hat{ } (−1.1831 * UEx.currentBandwidth + 7.783) + (propagation delay)
      graphPredictedLatency = e \hat{ } (−1.1831 * UEx.estimatedBandwidth + 7.783) + (propagation delay)
      UEx.predictedLatency = (UEx.currentLatency * graphPredictedLatency) / graphCurrentLatency
      In the same row of the table, fill in the chance.
  If UEx is a URLLC or a mIoT UE:
    Get the current loss of UEx. If that property is available:
      graphCurrentPacketLoss = max(0, (−3.0512 * UEx.currentBandwidth) + 5.2568)
      varianceRatio = UEx.currentPacketLoss − graphCurrentPacketLoss
      UEx.predictedPacketLoss = max(0, ((−3.0512 * UEx.estimatedBandwidth) + 5.2568) + varianceRatio)
      In the same row of the table, fill in the chance.
  If UEx is a conversational video UE:
    Get the current QoE of UEx. If that property is available:
      Estimated QoE = 3.661 + 0.8952 * In(UEₓ.predictedUsedShare)
      Estimated QoE = min( max(Estimated QoE, 1.0), 5.0)
      In the same row of the table, fill in the chance.
```

The value of the chance to fill in is not specified in the code above. It could for example be set to 100% as a starting point and or filled in with a more sophisticated formula.

The QoE formula is a fitted curve based on measurements performed on a prototype system. This was a non-overloaded system with just a single UE, where the QoE was measured for various values of given bandwidth shares for that UE. Note that QoE is between 1.0 and 5.0 by definition. The formulas for loss and latency were derived in a similar fashion. The formula for mIoT latency is just a simple rule-of-thumb. The formula for mIoT packet loss is in this example the same as URLLC packet loss. To derive better formulas for mIoT latency and loss, a similar procedure as for the other formulas would need to be performed.

Note that the way of deriving the formulates, by measurements performed by a human expert, can also be automated. Machine learning can be used to learn correlations between properties (for example, QoE correlates to bandwidth), and also to learn the correlation formula itself. In essence, a trained machine learning model is such formula.

The only dynamic properties that are not calculated in the pseudo-code above are “current flavour” and “requested flavour”. But these are less useful since those properties do not show (directly) in the KPIs anyway. In other words, the absence of rules to predict the properties of “current flavour” and “requested flavour” is also expert knowledge.

How to calculate the bandwidth shares is not explained in the pseudo-code above but is instead explained in the pseudo code below. It should be noted that the pseudo-code above is merely an example of a logical inference rule in the prediction agent 902. Basically, the pseudo-code is just a complicated formula to calculate bandwidth, utilizing the knowledge on how the prioritization of the traffic is implemented in the network.

### Pseudo-Code for Predicting Bandwidth

# Pseudo-code for predicting bandwidth

```
# From the current priority and the current MBR, calculate the current given share for each UE. The idea is to assign
available capacity according to the distribution imposed by the UE priorities, and up to each UE's MBR. This is done in a do-
loop that stops when there is no more capacity to assign, or when all UEs have reached their MBR limit.
# URLLC specifc consideration: Maximum throughput for URLLC is 3.2Mbps
For each UEy of type URLLC:
  If (UE.currentMBR > 3.2):
    UE.currentMBR = 3.2
For each UE_{y} in G: # where G is defined in the yellow box above
  UE_{y}.currentGivenShare = 0
Do:
  T_{ASSIGNABLE} = T_{CAPACITY} − Σ_{each UEy in G}(UE_{y}.currentGivenShare)
  sharesAssigned = false
  For each UE_{y} in G:
    Let G′ be the subgroup of G with those UEs where UE.currentGivenShare < UE.currentMBR
    If UE_{y} is not in G′ then continue with the next iteration of the for loop
    For each UE_{z} in G′:
      UE_{z}.ratio = ( Σ_{UEz in G′}(UE_{z}.currentUserPlanePriority) ) / UE_{z}.currentUserPlanePriority
    plusShare = ( UE_{y}.ratio / ( Σ_{UEz in G′}(UE_{z}.ratio) ) ) * T_{ASSIGNABLE}
    newShare = min(UE_{y}.currentGivenShare + plusShare, UE_{y}.currentMBR)
    If newShare > UE_{y}.currentGivenShare:
      UE_{y}.currentGivenShare = newShare
      sharesAssgined = true
Loop until sharesAssigned == false
# From the predicted priority and predicted MBR, calculate the predicted given share for each UE. Note that predicted
priority/MBR means either the new priority/MBR as defined in the action (if the UE is mentioned in the action), or the same
priority/MBR as the current one (if the UE is not mentioned in the action).
<< This is the same code as above, with predicted properties as input, and where the result is stored in
UE_{y}.predictedGivenShare >>
# Find out if the UE would take more bandwidth, if it would get a larger share. The idea is to see if the UE is using an amount
of traffic close to its limit (that is, close to its given share). If so, then the given share is likely a bottleneck for the UE. The
assumption is that the UE will take more if it gets more (that is, if its given share would be increased). Assuming the worst
case: the UE would use all its increased given share.
For each UE_{y} in G:
  If UE_{y}.currentThroughput > (UE_{y}.currentGivenShare * 90%):
    UE_{y}.inclinedToTakeMore = true
  Else
    UE_{y}.inclinedToTakeMore = false
# Make a first prediction of what each UE will use.
For each UE_{y} in G:
  If UE_{y}.predictedGivenShare < UE_{y}.currentThroughput:
    UE_{y}.predictedUsedShare = UE_{y}.predictedGivenShare
  Else:
    If UE_{y}.inclinedToTakeMore == true:
      UE_{y}.predictedUsedShare = UE_{y}.predictedGivenShare
    Else:
      UE_{y}.predictedUsedShare = UE_{y}.currentThroughput
# Finally, finish the prediction calculation by distributing the surplus link capacity amongst those UEs that are inclined to
take more bandwidth and that haven't reached their MBR.
<< This is the same code as the do loop described above, now for UE_{y}.predictedUsedShare. The only difference is the
definition of G′; that group is the subgroup of G with those UEs where UE.predictedUsedShare < UE.predictedMBR and
where UE.inclinedTo TakeMore == true >>
```

The result of step 402 for this example is illustrated in Appendix V below. In Appendix V, only the dynamic properties are shown, the configurable properties are condensed into a “ . . . ”. Only the users of conversation video and mIoT service are shown; other UEs are not shown for readability and condensed into a“ . . . ”. In this example, only UE31 and UE32 share a transport segment with at least one of the UEs listed in the action (that is, UE11 and UE12). Note that some estimates new values are not filled in; in the table they are set to “−”. These are the properties that do not change; the chance of impact is 0%.

As a result of step 402, the predicted values of all measurable properties are obtained: the type of each property is known (Appendix I); static properties by definition do not change; it is known which configurable properties will change and to which value (Appendix IV); and finally, it is known which dynamic properties will change and to which values (Appendix V). The question is then, given the new property values, what will the new KPI values become?

In step 404, the predicted measurable property values are converted into predicted KPI values. The aim is to arrive at the table in Appendix VI, which is the filled in version of Appendix II. In the table in Appendix II, the two rightmost columns have been filled in with the expected change. No change is expected in those cell that have not been filled in.

Calculating the estimated KPIs from the estimated properties is the same procedure (logical inference rule) as calculating the measured KPI from the measured properties. The chance that this will happen (rightmost column) could be a simple averaging of the chances associated with the estimated properties involved (see Appendix V).

The following pseudo-code shows an example of how a KPI is calculated for a threshold metric expectation. For the other KPIs a similar flow and required components applies. A threshold metric expectation targets a (certain percentage of) users and states that the value of a specific attribute (e.g., QoE) shall be above or below a specific target.

As a concrete example let's focus on the KPI on the first row of the table above: “>=90% of users shall have >=4.0 QoE”. This expectation can be formally expressed in the following manner:

```
zt:conversational-video-intent-expectation
  a zt:ThresholdedMetricGreaterThanExpectation ;
  cc:target ne:video_usrg_group_instance;
  cc:hasContext ne:conversational_video_service_instance;
  cc:percent 0.9;
  cc:params [
    tel:qualityOfExperience 4.0
  ] .
```

The metric that is used to calculate the KPI fulfilment in this example (see code above) is zt:ThresholdMetricGreaterThanExpectation, because it specifies that the level of QoE should be above the specified target for a certain percentage of the user group.

The intent manager 100 is equipped with the specification of such a metric in its knowledge base, allowing its use for expectations (see code below)

```
:ThresholdMetricGreaterThanExpectation
  a rdfs:Class ;
  rdfs:subClassOf :UserEquipmentGroupMetricExpectation;
    :handledBy :metric-gt-handler.
```

The key element for calculating the KPI fulfilment is the metric handler, that is a function used to calculate the current value of a specific metric. In our example (see code above) this is: threshold-max-metric-handler. This specific metric handler works as the following pseudocode shows:

UE_x = { UEx : UE in target service group } # target is param. of expectation
metric = { UE.metric : UE in UE_x } # collect metric values UEs in group
metric.sort(how=′descending′) # sort direction depends on expectation
index = ceil(len(metric) * percent) # percent − parameter of expectation
percentile_value = metric[index] # find the metric “at” given percentile
return percentile_value > threshold # threshold is parameter of expectation

Once the value of the KPI is computed via the metric handler the intent manager compares the expected value (specified in the intent) with the newly calculated current value of the KPI. If the latter do not comply with the expressed requirement the intent manager will raise an unmet expectation.

In summary, in the example above, the KPI calculation depends on the specific metric used in the expectations of an intent. The metrics are specified in the intent manager and have a handler associated to them. The handler is in charge of computing the current value of the KPIs given the required properties as input. The intent manager uses the output of the metric handler to evaluate if the expectation is met.

Note that a simplification is made: some properties (like bandwidth) come in downlink and uplink. In the tables in the Appendixes I-VI no distinction is made between uplink and downlink, whereas in a real implementation, this distinction will need to be made.

Furthermore, in the example described above, only a single prediction agent is described. A real implementation may support multiple different actions and each action would have its own prediction agent. These prediction agents would follow the same structure and principles, but their implementation would be different.

Turning now to other embodiments, current intent-based framework and definitions do not define how to indicate which intents are more important than others. As time goes on, there will be multiple intents simultaneously active within a single intent manager, and as resources are limited, there may be situations where not all intents can be fulfilled.

In brief, what is proposed herein is a penalty-based mechanism that can be used to select an action (e.g. from a plurality of possible actions) to perform. The main idea is that intents specify their penalty. This penalty is the “cost” of partially satisfying or not satisfying a specific intent. The penalty may be specified in the intent as a formula. The penalty could also be specified separately from the intent, but be submitted with it. In addition, another formula for calculating the overall penalty within the intent manager (the so-called system penalty) as a function of the individual intent penalties can be provided. The cognitive system calculates at runtime the current penalty of every active intent and the total system penalty. These knowledge objects are used to perform reasoning and provide a mechanism to prioritize between intents with respect to their relative importance when executing actions aimed at reconfiguring the network. Therefore, a mechanism provided for prioritising between (potentially conflicting) intents is provided.

The penalty-based mechanism may be used as part of the method 400 described above, or more generally, as part of any method for selecting an action to perform from a plurality of possible actions, where the effects of the actions on the measured KPIs in the system are predicted (e.g. using any method).

In more detail, in some embodiments, the first intent further comprises penalties to be applied if the expectations in the first intent are not satisfied (e.g. not met/achieved). The penalties may quantify an impact of the KPI targets for the expectations not being satisfied. Each penalty may be expressed as a score. There may be one penalty associated with each expectation. Penalties may be relative, e.g. set on a relative scale, to indicate the relative importance of each expectation compared to other expectations in the first intent and/or other expectations in other intents. As such, the penalty values may be normalised.

A system penalty may be calculated, for the whole system. The system penalty may be an aggregation of the individual penalties associated with the expectations set in all of the intents for the system. In this sense, an aggregation refers to a mathematical combination of the penalties, such as, for example, a summation of the penalties, an average of the penalties, a mean of the penalties, a max of the penalties, or any other mathematical combination of the penalties.

Thus, the method 400 may further comprise determining a first system penalty, wherein the first system penalty is determined using a penalty formula for aggregating penalties accrued by not meeting one or more of the expectations in the first intent and/or one or more expectations in other intents set for the system. For example, the system penalty may aggregate all of the penalties that apply to the system, taking all of the unsatisfied expectations into account across all intents set for the system. (e.g, the sum of the penalties for all intents). In other examples, the first system penalty may be an aggregation of a subset of the expectations in the intents set for the system (for example the most important expectations). In this sense, the first system penalty is the “current” system penalty for the system, as determined from measured KPI values.

It will be appreciated that if there is more than one intent set for the system, then the first system penalty may be an aggregation of the penalties associated with all of the expectations that are not met, for any of the intents in the system. Thus, the system penalty may be calculated based on more than one intent if there is more than one intent defined for the system.

Penalties may further be predicted for the actions proposed by the proposal agent 112, from the predicted KPI values for the system, output in step 404 above. The predicted system penalties can thus be used to select an action from two or more proposed actions.

For example, in some embodiments, the method 400 comprises using the outputs of the step of comparing 406 the predicted KPI values to the KPI targets in the first intent, to predict a second system penalty if the first action were to be performed. In other words to predict a system penalty that would apply if the first action were to be performed in the system.

The decision on whether to perform the first action may then be based on the predicted second system penalty value. For example, the first action may be selected if the predicted second system penalty is less (e.g. more favourable) than the first system penalty. In other words, the first action may be selected if it is predicted to reduce the system penalty.

In some embodiments, the first action may be selected if the predicted second system penalty is equal to (e.g. no less favourable) than the first system penalty. For example, if the first action would result in resolution of an issue without changing the system penalty, then this action may be selected.

A system penalty criterion (or criteria) may be used to indicate how predicted system penalty values are to be evaluated. Such a system penalty criterion may be set as an expectation in the first intent.

As an example, the method 400 may further comprise selecting the first action if the predicted second system penalty satisfies a system penalty criterion set in a third (e.g. another) intent set for the system, wherein the system penalty criteria provides an indication of a manner in which to determine, based on the first system penalty and the second system penalty whether the first action should be selected.

For example, the system penalty criterion may set a threshold penalty that the system penalty should not exceed. Alternatively or additionally, the system penalty criterion may indicate that the system penalty should be minimised, maximised, optimised, or indicate any other criteria which can be used to select one action over another, based on their associated predicted system penalty values. (Note that maximising the system penalty may be appropriate if the penalty values are defined such that a more positive penalty is more desirable in the system than a negative one.)

The penalties (e.g. values thereof), penalty formula, penalty criterion and/or any other penalty related information may be set by a second node in the communications system. In other words, the second node may instruct the first node as to the penalties (e.g. values thereof), penalty formula, penalty criterion and/or any other penalty related information.

The second node may be configured to perform the method 1100 described below. For example, the second node may comprise a memory comprising instruction data representing a set of instructions, and a processor configured to communicate with the memory and to execute the set of instructions. The set of instructions, when executed by the processor, may cause the processor to perform the method 1100 described below. Memory, processors and instructions were all described above with respect to the first node 300 and the detail therein will be understood to apply equally to the second node.

The second node may be any node that is used to set the intents for the system e.g. an intent owner 102. An intent owner may formulate the intent(s) for the system and instruct the first node (intent manager) to assure (satisfy) the formulated intent.

Thus, the second node may be operated by an owner of the first intent and/or other intents defined for the system. The second node may be comprised in an intent handler provided as a service in the communications network. In some examples, the second node may be an intent manager and the first node and the second node form may form part of a hierarchy of intent managers.

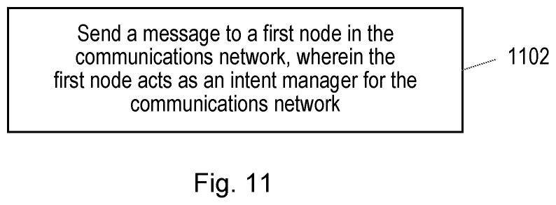

The second node may perform the method illustrated in FIG. 11. The method 1100 is for network for satisfying a first intent set for a system in the communications network, wherein the first intent comprises expectations, each expectation corresponding to a Key Performance Indicator, KPI, target. Intents, expectations, KPIs and KPI targets were all described with respect to the method 400 above, and the detail therein will be understood to apply equally to the method 1100.

In step 1102 the method 1100 comprises: sending a message to a first node in the communications network, wherein the first node acts as an intent manager for the communications network, and wherein the message comprises the first intent for the system and one or more penalties to be applied if the expectations in the first intent are not satisfied.

As noted above, with respect to the method 400, the penalties may quantify an impact of the KPI targets for the expectations not being met. Furthermore, the message may further comprise an indication of a penalty formula for use in determining a system penalty, wherein the system penalty is an aggregation of penalties accrued by not meeting one or more of the expectations in the first intent, and/or one or more other expectations in other intents set for the system.

In some examples, one of the expectations may set a system penalty criterion that provides an indication of a manner in which to determine, based on predicted penalties associated with one or more actions and/or the system penalty, whether to perform one or more of the actions.

Penalties, the system penalty, the penalty formula and the system penalty criterion were all described above with respect to the method 400 and the detail will be appreciated to apply equally to the method 1100.

Thus there is provided, a mechanism to calculate penalties for each individual intent, a mechanism to calculate the system penalty as a function of the individual penalties, and a closed loop management of system penalty via intents. The main advantage of this solution (over an intent manager without a prioritization mechanism between intents) is the possibility of executing reconfiguration actions that comply with the relative importance of each intent in case of resource contention. Moreover, the importance of each intent, specified via a penalty mechanism, allows the intent manager, e.g., to minimize at runtime KPI violation in the network and potentially save incurring costs due to SLA violations

Turning now to an example of penalty-based system. In this example the functional and non-functional requirements of an application are submitted to an intent manager 100 via intents by an intent owner, e.g., an operator 102. The intents are stored in the knowledge base 108 of the intent manager 100. As an example, let's focus on the following conversational video intent:

```
            zt:conversational-video-intent
  a icm:Intent;
  rdfs:label “Conversational video intent” ;
  icm:hasExpectation zt:conversational-video-intent-exp-1, zt:conversational-video-
intent-exp-2, zt:conversational-video-intent-exp-3, zt:conversational-video-intent-
exp-4 ;
zt:conversational-video-intent-exp-1
    # Service Up
    a icm:PropertyEqualExpectation ;
    icm:target ne:conversational_video_service_instance;
    icm:params [
        zt:serviceType tel:ConversationalVideoService ;
    ] .
zt:conversational-video-intent-exp-2
    # Service Up
    a icm:PropertyEqualExpectation ;
    icm:target ne:conversational_video_service_instance;
    icm:params [
        tel:usrGrp ne:video_usrg_group_instance;
    ] .
zt:conversational-video-intent-exp-3
    #QoE greater than 4 for 80% of users
    a zt:ThresholdedMetricGreaterThanExpectation ;
    icm:target ne:video_usrg_group_instance;
    icm:hasContext ne:conversational_video_service_instance;
    icm:percent 0.8;
    icm:params [
        tel:qualityOfExperience 4.4
    ] .
      #MBR=10 for 100% of users
zt:conversational-video-intent-exp-4
      a zt:UserEquipmentGroupPropertyEqualsExpectation;
      icm:target ne:video_usrg_group_instance;
      icm:hasContext ne:conversational_video_service_instance;
      icm:params [
          tel:mbr 10
      ] .
```

This intent has four expectations:
A running instance of conversational video
A user group connected to the intent instance
At least 80% of users of the conversational video have QoE>4.4
All the users of the group have MBR=10

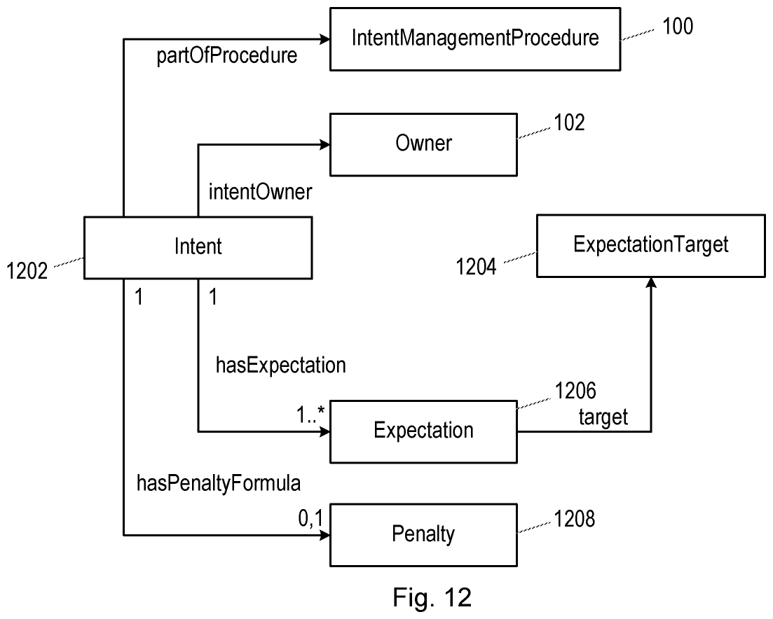

As noted above, according to embodiments herein, in addition to the expectations, the intent defines a penalty formula, that is the cost (specified in some unit) of not fully satisfying the intent. FIG. 12 shows the intent common model as described in FIG. 3.3 of the TM Forum IG1253 v1.1, extended it to embed the penalty specification 1208. FIG. 12 indicates the class hierarchy for intents 1202, expectations 1206 and expectation targets (e.g. KPI targets) 1204, and how they are related to the intent manager 100 and Owner 102. More details on this FIG. 12 is found in the TM forum documentation cited above.

A penalty formula specifies how to perform (possibly complex) calculations for computing the current penalty value of an intent. In the following example, suppose that the penalty formula is expressed, by using RuleML, a semantic and interoperable language, although it will be appreciated that this is merely an example and that any other language could equally be used.

```
      Prefix(ex <http://example.com/2022/ivds/penalty#>)
(* ex:penalty_formula *)
ex:currentPenalty−>0
Forall ?expectation (
  If (?expectation[ex:isSatisfied−>false])
    Then Do (Modify(?intent[ex:currentPenalty−>10]))
)
```

In the example above, the current penalty is zero, if all the expectations are met, and equals to 10 if at least one expectation of the intent is not met. In another version, the current penalty value would be calculated with another formula. For example, if there is an expectation on the QoE, and that is not met, the current penalty will depend on how far the system is from the target QoE.

In another example, we can also prioritize between expectations in a single intent. Referring to the conversational video intent introduced above, the current penalty of the intent can be calculated in the following manner:

### Current_Penalty=

a, if QoE expectation is not met but the MBR expectation is met;
b, if MBR expectation is not met, but QoE expectation is met
   a+b, if both QoE and MBR are not met.
   0, otherwise

If a>b then i it could be indicated that not meeting the QoE expectation incurs a higher penalty than not meeting the MBR expectation. In the later step, the intent manager 100 can use this knowledge to prioritize over one expectation of the intent or the other.

Using RuleML this rule might be specified as following:

```
Prefix(ex <http://example.com/2022/ivds/penalty#>)
(* ex:another_penalty_formula *)
ex:currentPenalty−>0
Forall ?expectation (
  If (?expectation[ex:isSatisfied−>false])
    If(?expectation[ex:metric−>QoE])
      Then Do (Modify(?intent[ex:currentPenalty−>ex:currentPenalty+a]))
    If(?expectation[ex:metric−>MBR])
      Then Do (Modify(?intent[ex:currentPenalty−>ex:currentPenalty+b]))
)
```

When the intent manager 100 onboards an intent, it can take the specification of its penalty formula and (if necessary) performs code to code transformation to make the formal specification of the penalty code executable in the intent manager. Note that this step might not be necessary if the penalty formula is specified with a language that is directly understood by the intent manager.

As an illustrative example, the intent manager translates “ex:penalty_formula”, the first example formula mentioned above, as a Relation that allows for calculating the penalty at every point in time. In the code below the intent manager finds (i.e., match) all the expectations that are met, then in the conditional expression (i.e., cond), if there aren't any issue related to that expectation the penalty value will be 0, otherwise it will be 10.

```
:penalty-formula
  a r:ManualRelation ;
  r:assuming [ zt:intent v:Intent ;
          zt:penalty v:Penalty
      ] ;
  r:situation [ r:id v:Intent ;
        ] ;
  r:where ( ( “ignore” ( “match” [ r:id v:Intent ;
                icm:hasExpectation v:Exp ;
              ]
              [ r:id v:Issue ;
                r:graph v:_ ;
                a icm:UnmetExpectation ;
                icm:expectation v:Exp
              ] ) )
    ( “cond” ( “var” v:Issue ) ( “=” v:Penalty 0 )
            ( “else” ) ( “=” v:Penalty 10)
    ) ) .
```

The intent penalty value is always updated because the intent manager triggers at every knowledge change a re-computation of the current intent penalty is executed. Finally, the current penalty value of the intent is stored in a dedicated knowledge graph (e.g., “penalty-graph”).

The knowledge graph stored in the intent manager's knowledge base, i.e., a set of linked terms describing entities either from the real world or abstract concepts, their properties and relations. The descriptions themselves align to an agreed semantics (ontology) and syntax (in this case RDF), making the graph both human and machine readable and processable.

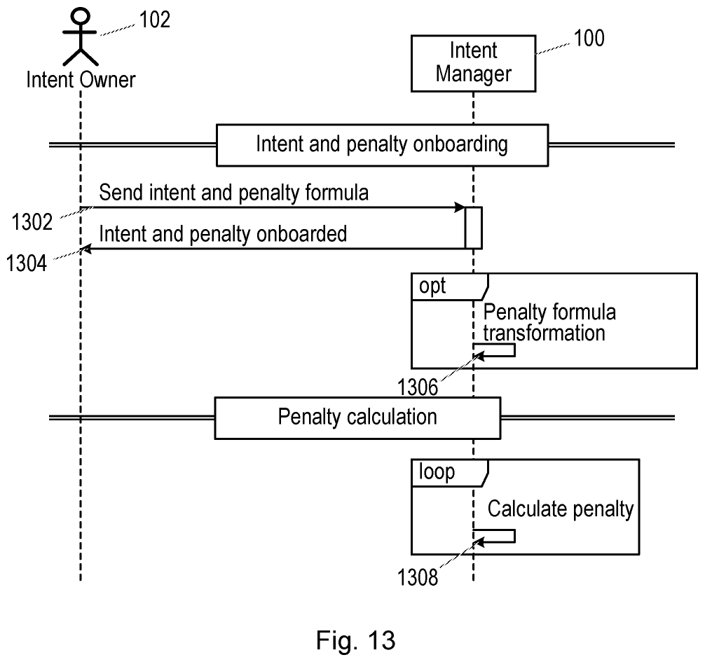

FIG. 13 shows how an intent and its penalty formula are onboarded. In step 1302 the intent owner (e.g second node) sends the intent and penalty formula to the intent manager 100. The Intent Manager acknowledges receipt in message 1304. As noted above, in 1306 the penalty formula may need to be translated, depending on the manner in which the intent and penalty formula are expressed. After intent onboarding the intent manager 100 continuously calculate 1308 the updated penalty value of each intent.

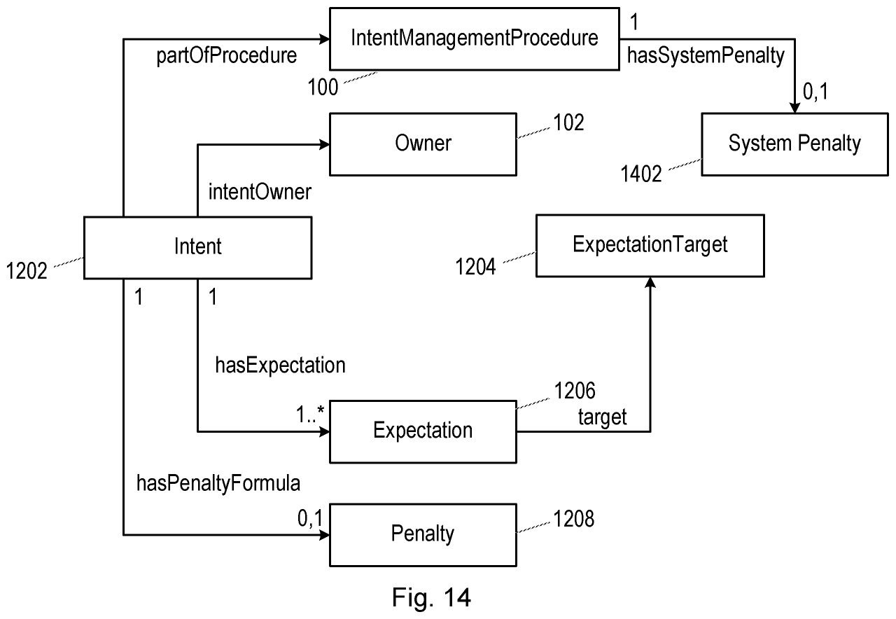

The Intent manager 100 further calculates the system penalty. The concept of system penalty formula is associated with an intent management procedure (i.e., process of an intent manager). The system penalty formula may be inserted, for example by an Operator, a provider of the network infrastructure, another intent manager, or any other second node as described above. Once the penalty of each intent is defined, the system penalty formula specified within the intent manager allows the system penalty to be calculated. FIG. 14 extends the TM forum intent common model with the system penalty 1402 (and the previously introduced intent penalty 1208).

A system penalty formula specifies how to perform (possibly complex) calculations for computing the overall penalty value of an intent manager. A common language for specifying the system penalty is not in the standard yet (e.g., TM forum), but, in the following example, suppose that the system penalty formula is expressed, using RuleML.

Prefix(ex <http://example.com/2022/ivds/penalty#>)
(* ex:system_penalty_formula *)
ex:systemPenalty−>0
Forall ?intents (
Then Do (Modify(systemPenalty=systemPenalty+intent[ex:currentPenalty]))
)

In the above example, the system penalty is defined as the sum of all the intent penalties in the intent manager. In another version, the system penalty value could be calculated with another, more sophisticated, formula where, e.g., intents of the service type “URLLC” get twice the weight compared to the type “video”.

The intent manager takes the specification of the system penalty formula and (if necessary) performs code to code transformation to make the formal specification of the penalty code executable in the intent manager. Note that this step might not be necessary if the system penalty formula is specified with a language that is directly understood by the intent manager. However, as previously mentioned, this language is not in the standard yet, so a translation step might be necessary.

In the code below, as an illustrative example, the intent manager translates the RuleML formula “ex:system_penalty_formula” (the code of the RuleML formula introduced above describes the behavior of the following code).

```
          :system-penalty-formula
a r:Rule ;
r:match
[ r:id :timestamp ;
        r:graph “penalty-graph” ;
        rdf:value v:V
],
[
  r:graph “penalty-graph”;
  r:id v:systemPenalty;
  a icm:SystemPenalty ;
  zt:systemPenalty v:systemPenaltyValue
];
r:where (
  (“findall” v:value (“match”
    [
      r:graph “penalty-graph”;
      r:id v:penalty;
      a icm:Penalty ;
      zt:intentPenalty v:value;
    ]) v:penalties
  )
  ( “sum_list” (“quote” v:penalties) v:sum-of-penalties)
  (“not” (“==” v:systemPenaltyValue v:sum-of-penalties))
);
r:retract [
  r:graph “penalty-graph”;
  r:id v:systemPenalty;
  zt:systemPenalty v:systemPenaltyValue;
];
r:assert [
  r:graph “penalty-graph”;
  r:id v:systemPenalty;
  zt:systemPenalty v:sum-of-penalties
].
```

This rule enables, at each point in time, the intent manager to know the system penalty value. The system penalty is again stored in the knowledge graph (e.g., penalty-graph).

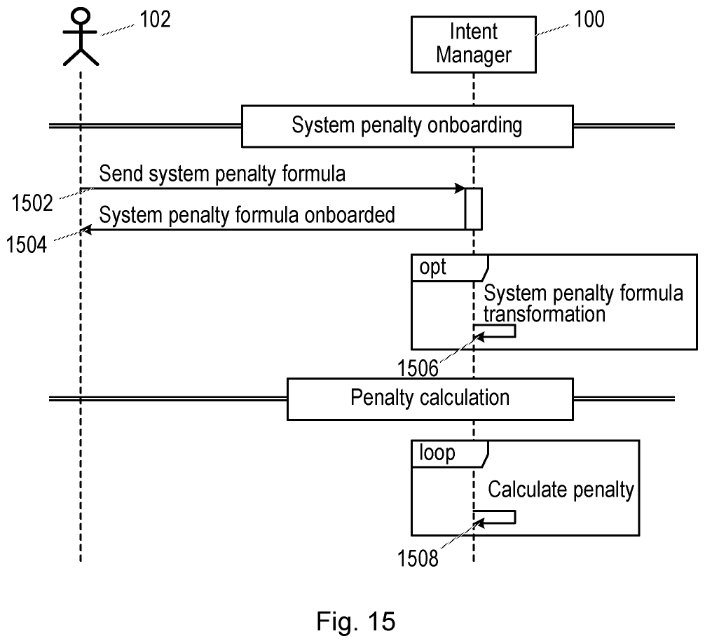

FIG. 15 shows how a system penalty formula is onboarded in the system. The system penalty formula may be sent to the intent manager 100 by the Operator 102 (or more generally second node) in message 1502. The Intent manager acknowledges this in message 1504. The system penalty formula may be translated into a form readable by the intent manager 100 in step 1506. The penalty is then calculated in a looped (e.g. ongoing manner) in 1508. The “calculate penalty loop” may thus be an activity updating both the penalty value of each intent and the system penalty value.

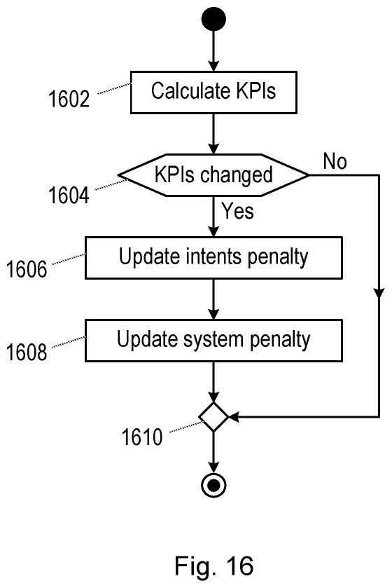

This is illustrated in FIG. 16 which shows how the penalty value of each intent and the system penalty are continuously updated. FIG. 16 may be summarised as follows:
1. Each intent is associated with a penalty formula
2. The intent manager calculates each intent penalty in 1606 (e.g, using measured KPI values obtained in 1602) every time the measured KPIs change 1604 and/or expectations change their state (i.e., met/unmet).
3. The intent manager calculates the total system penalty 1608 (based on the system penalty formula and the outputs of step 1606).
4. The information is stored in the knowledge base 108 of the intent manager 100 in a penalty-graph, ready to be used by other modules to perform reasoning tasks.

The penalty-graph below shows that the penalty for the conversational-video-intent is 10, for the urllc-intent it is 1, and the system penalty in this case is 11.

```
  @base <penalty-graph>.
@prefix zt: <https://ailab.rnd.ki.sw.ericsson.se/zero-touch/> .
@prefix icm: <https://www.tmforum.org/2020/07/IntentCommonModel/> .
@prefix xsd: <http://www.w3.org/2001/XMLSchema#> .
icm:penalty-c96ab2a4-79cb-11ec-b7fd-37403606d4fd
  a icm:Penalty ;
  icm:intent zt:conversational-video-intent ;
  zt:intentPenalty 10 .
icm:penalty-d9jk221l-79cb-11ec-n54t-45633606d4aq
  a icm:Penalty ;
  icm:intent zt:urllc-intent ;
  zt:intentPenalty 1 .
zt:penalty
  a icm:SystemPenalty ;
  zt:systemPenalty 11 .
```

It will be appreciated that this is merely an example and that the penalty values of each intent and the system penalty may be stored in a different manner to that illustrated in the example above.

The purpose of the system penalty formula can be to minimise the system penalty induced by the intents. However, this is just an example and other requirements might be specified. For example the system penalty might be kept under a certain threshold. The following example focuses on a minimization requirement without losing generality. To this end, another intent may be inserted. The intent specifies an expectation that minimizes the system penalty of the intent manager (i.e., zt:penalty).

```
zt:penalty-intent
  a cc:Intent;
  rdfs:comment “Global penalty intent”;
  icm:hasExpectation zt:penalty-intent-exp-1 .
zt:penalty-intent-exp-1
  a icm:MinimizationExpectation ;
  icm:target zt:systemPenalty.
```

If an intent has a penalty, it means that too few resources were assigned to fulfil all the expectations. The way to solve this is to free up resources from other intents that either do not have a penalty, or where the resource shortage would cause a smaller penalty.

Example actions to free up resources would be reducing user plane packet priority, reducing data centre compute allocation (aka autoscale limit), or to decrease the maximum bit rate (MBR) of the users. These measures can be taken if there are mechanisms such as the method 400 described above with which to predict the outcome of the proposed actions on the penalties of all the involved intents.

The system instantiates a logical closed loop to find an action leading to the lowest system penalty. The high level logical closed loop flow is the following:
Collects: System penalty and penalty per intent
Analyses: Compare all the intent penalty values, find actions to lower the system penalty
Decides: Which action to pick. The action that brings down the system penalty most may be prioritized.
Executes: The decided action. (e.g., lower user plane packet priority, reduce autoscale limit, set MBR)

Referring to the intent manager 100, introduced in FIG. 1, the logical loop is instantiated in the multi-agent architecture shown in FIG. 2 as follows:

Data grounding agent 110: a dedicated grounding agent is not generally needed for calculating penalties because penalty data is not monitored from the environment. In fact, the intent penalty values, and the system penalty are already calculated and available in the knowledge base (see above). This information can be used by the intent manager to evaluate if the expectation related to the system penalty is met or not.

Proposal agent 112: If the intent manager evaluates that the penalty intent is not satisfied, e.g., in case of minimization means that the system penalty is greater than zero, it creates an unmet expectation that is captured by a penalty proposal agent. The pseudocode for the penalty proposal agent is the following:

Let G be the set of intents with the lowest penalty KPI (multiple intents can have the
same, lowest, value)
Pick Y at random from G
Propose a set of actions A to reduce resources associated with Y

An example of this set of actions is: A=(A_1->{lower user plane priority of Y}, A_2->{decrease MBR of Y). In another case, the system might detect, through reasoning, that the resource contention happens at the data center side (not in the access network) and that a proper action would be A=(A_1->decrease autoscale limit of server containers associated with Y)

Evaluation agent 114: Proposal(s) are evaluated by an evaluation agent that select, among multiple actions, a subset of actions to be executed. Note that this evaluation agent does not evaluate only penalty agent proposed actions, but also other actions that are simultaneously submitted to deal with other KPIs. The method 400 described above can be used to detect conflicts between multiple KPIs during run-time by predicting the effect of one action on all KPIs. Once we have predicted the effects, it is possible to assess which actions shall be executed or not. The penalty-based mechanism proposed herein can tackle the problem of how to pick among multiple, possibly conflicting, actions. The solution, based on the penalty-based mechanism can be described as follows:

Each intent is associated with a penalty formula when is onboarded in the system. This value quantifies the impact of the intent's KPI violation (e.g., price to pay for violating SLAs)

The system collects the actions that are proposed to be executed, together with their predicted KPI values (obtained using the method 400 described above), in other words, their predicted impact on all the KPIs (<A_1,I_1>, <A_2,I_2>, . . . , <A_n,I_n>).

In this example, the system selects the action(s)<A_j,I_j> leading to the lowest system penalty. Since the impact “I_j” on the KPIs is associated with the action “A_j”, it is possible to calculate the impact of the action on the intents' penalties (i.e., predicted intent penalties) and, consequently, calculate the predicted system penalty. Finally, the evaluation agent executes the following logic:

```
IF predicted system penalty > current system penalty THEN
    reject the action
ELSE
  grant the action
```

Actuator agent 116: The selected action(s) is executed in the environment by using specific actuators (e.g., packet priority actuator, autoscale limit actuator, MBR actuator), depending on which actions were granted.

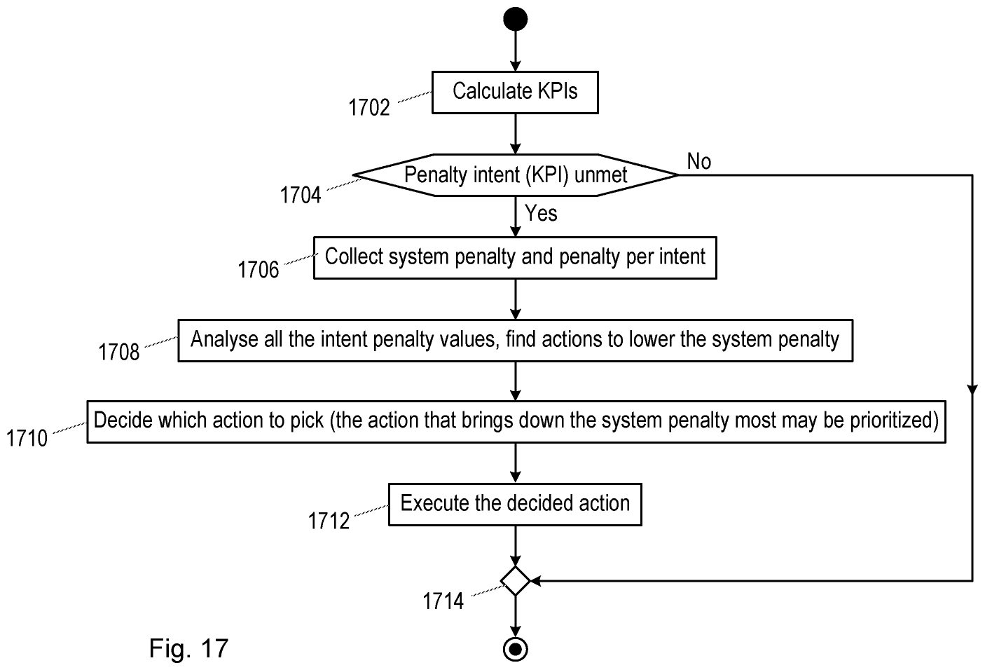

This is summarised in FIG. 17 which shows the following steps:
1702: KPIs are measured for the system.
1704: Based on the measured KPIs, a penalty is determined if a KPI target (for an expectation) is unmet.
1706: The system penalty and penalty per intent is then determined
1708: The intent penalty values are analysed and one or more actions to lower the system penalty are determined.
1710: This step uses the method 400 to predict KPI values that would arise from the different actions being performed. Predicted system penalties (if the actions were performed) can then be calculated and the predicted system penalties can be used to determine which action(s) to select in order to reduce the system penalty.
1712: The selected action is performed
1714: The loop begins again.

Turning now to other embodiments, there is also provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

APPENDIX I

| Property | Agent | Type |
|---|---|---|
| UEs, nodes (gNBs and UPFs) and DCs available in the | Topology | Static |
| system. | | |
| Transport links between these entities. | Topology | Static |
| For each transport link: bandwidth (capacity), propagation | Topology | Static |
| delay | | |
| For each DC: memory, disk and compute | Kubernetes | Static |
| For each DC: fixed and per UE energy consumption | Kubernetes | Static |
| For each DC service instance: type | Kubernetes | Configurable |
| For each UE: gNB attached to, DC served by, user plane | UE | Configurable |
| priority, MBR | | |
| For each DC service instance: autoscalelimit | Kubernetes | Configurable |
| For each DC service instance: current flavour | Kubernetes | Dynamic |
| For each DC service instance: requested flavour | Kubernetes | Dynamic |
| For each UE: packet loss (UL and DL), throughput (UL and | UE | Dynamic |
| DL) | | |
| For each UE of service type URLLC or mIoT: latency | UE | Dynamic |
| For each UE of service type conversational video: QoE | UE | Dynamic |

Explanatory Notes:
DC is a Data Center where functions like UPFs and applications servers run. A DC service instance is the collection of resources (memory, disk, compute) assigned to a service running at a particular DC. Scaling of such service instance can be controlled by changing the so-called “autoscalelimit” and can be monitored through information like “current flavour” and “requested flavour” (these are Kubernetes terms; see the Kubernetes Manual (2022) for more detailed information).
Each service is of a certain type, example types are: conversational video, URLLC (Ultra-Reliable Low-Latency Communication) and mIoT (massive Internet of Things).
UL refers to uplink and DL refers to downlink.

| | | | | | APPENDIX II | |
|---|---|---|---|---|---|---|
| | | | | | Predicted values | |
| Measured or set values | | | | | KPI | |
| | KPI | | KPI | KPI | Estimated | |
| | name | Full KPI description | measured | target | new value | Chance |
| Conv | QoE | >=90% of users [UE11, 12] | 0% | >=90% | ? | ? |
| video | | shall have >=4.0 QoE | | | | |
| | MBR | 100% of users [UE11, 12] | 100% | >=100% | ? | ? |
| | | shall have MBR 10 Mbps | | | | |
| URLLC | Latency | 100% of users [UE21, 22, 23, 24] | 75% | >=100% | ? | ? |
| | | shall have <=5 msec latency | | | | |
| | Loss | 100% of users [UE21, 22, 23, 24] | 50% | >=100% | ? | ? |
| | | shall have <=1 out of 10⁶ loss | | | | |
| | MBR | 100% of users [UE21, 22, 23, 24] | 100% | >=100% | ? | ? |
| | | shall have MBR 10 Mbps | | | | |
| mIoT | Latency | >=75% of users [UE31, 32, 33, 34] | 100% | >=75% | ? | ? |
| | | shall have <=5 msec latency | | | | |
| | Loss | >=75% of users [UE31, 32, 33, 34] | 50% | >=75% | ? | ? |
| | | shall have <=1 out of 10⁶ loss | | | | |
| | Energy | 100% of users [UE31, 32, 33, 34] | 0% | >=100% | ? | ? |
| | | shall have energy consumption 0 | | | | |
| | MBR | 100% of users [UE31, 32, 33, 34] | 100% | >=100% | ? | ? |
| | | shall have MBR 10 Mbps | | | | |

APPENDIX III
Initialization of a table of predicted measurable properties

| | Chance that the | |
|---|---|---|
| | property is | |
| | impacted by the | Current |
| Property | action | value |
| One row per DC service instance: type | 0% | xyz |
| One row per UE: gNB attached to | 0% | xyz |
| One row per UE: DC served by | 0% | xyz |
| One row per UE: user plane priority | 0% | xyz |
| One row per UE: MBR | 0% | xyz |
| One row per DC service instance: current flavour | 0% | xyz |
| One row per DC service instance: requested flavour | 0% | xyz |
| One row per UE: packet loss | 0% | xyz |
| One row per UE: bandwidth (throughput) | 0% | xyz |
| One row per URLLC and mloT UE: latency | 0% | xyz |
| One row per conv video UE: QoE | 0% | xyz |

APPENDIX IV
Predicted properties table with configurable properties filled in

| | Chance that the | | |
|---|---|---|---|
| | property is | | |
| | impacted by the | Current | Estimated |
| Property | action | value | new value |
| One row per DC service instance: type | 0% | xyz | |
| One row per UE: gNB attached to | 0% | xyz | |
| One row per UE: DC served by | 0% | xyz | |
| UE11: user plane priority | 100% | X | Y |
| UE12: user plane priority | 100% | X | Y |
| One row for all other UEs: user plane priority | 0% | xyz | |
| One row per UE: MBR | 0% | xyz | |
| One row per DC service instance: | 0% | xyz | |
| autoscalelimit | | | |
| . . . | | | |

APPENDIX V

| | Chance that | | | | |
|---|---|---|---|---|---|
| | the property is | | | | |
| | impacted by | Current | | Estimated | |
| Property | the action | value | | new value | |
| . . . | | | | | |
| One row per DC service | 0% | xyz | | — | |
| instance: requested | | | | | |
| flavour | | | | | |
| UE11: packet loss | 100% | 2 out | | 1.5 out | |
| | | of 10⁶ | | of 10⁶ | |
| UE12: packet loss | 100% | 3 out | | 2.5 out | |
| . . . | | of 10⁶ | | of 10⁶ | |
| UE31: packet loss | 100% | 4 out | | 4.2 out | |
| | | of 10⁶ | | of 10⁶ | |
| UE32: packet loss | 100% | 2 out | | 2.1 out | |
| | | of 10⁶ | | of 10⁶ | |
| UE33: packet loss | 0% | xyz | | — | |
| UE34: packet loss | 0% | xyz | | — | |
| UE11: bandwidth | 100% | 6 | Mbps | 7 | Mbps |
| UE12: bandwidth | 100% | 4 | Mbps | 5 | Mbps |
| . . . | | | | | |
| UE31: bandwidth | 100% | 5 | Mbps | 4.5 | Mbps |
| UE32: bandwidth | 100% | 4 | Mbps | 3.5 | Mbps |
| UE33: bandwidth | 0% | xyz | | — | |
| UE34: bandwidth | 0% | xyz | | — | |
| UE31: latency | 100% | 50 | ms | 48 | ms |
| UE32: latency | 100% | 40 | ms | 38 | ms |

| | | | |
|---|---|---|---|
| UE33: latency | 0% | xyz | — |
| UE34: latency | 0% | xyz | — |
| UE11: QoE | 100% | 2.0 | 3.0 |
| UE12: QoE | 100% | 1.5 | 2.3 |

| | | | | | APPENDIX VI | |
|---|---|---|---|---|---|---|
| | | | | | Predicted values | |
| Measured or set values | | | | | KPI | |
| | KPI | | KP | KP | Estimated | |
| | name | Full KPI description | measured | target | new value | Chance |
| Conv | QoE | >=90% of users [UE11, 12] | 0% | >=90% | 0% | 100% |
| video | | shall have >=4.0 QoE | | | | |
| | MBR | 100% of users [UE11, 12] | 100% | >=100% | — | — |
| | | shall have MBR 10 Mbps | | | | |
| URLLC | Latency | 100% of users [UE21, 22, 23, 24] | 75% | >=100% | — | — |
| | | shall have <=5 msec latency | | | | |
| | Loss | 100% of users [UE21, 22, 23, 24] | 50% | >=100% | — | — |
| | | shall have <=1 out of 10⁶ loss | | | | |
| | MBR | 100% of users [UE21, 22, 23, 24] | 100% | >=100% | — | — |
| | | shall have MBR 10 Mbps | | | | |
| mIoT | Latency | >=75% of users [UE31, 32, 33, 34] | 100% | >=75% | 75% | 100% |
| | | shall have <=5 msec latency | | | | |
| | Loss | >=75% of users [UE31, 32, 33, 34] | 50% | >=75% | 50% | 100% |
| | | shall have <=1 out of 10⁶ loss | | | | |
| | Energy | 100% of users [UE31, 32, 33, 34] | 0% | >=100% | — | — |
| | | shall have energy consumption 0 | | | | |
| | MBR | 100% of users [UE31, 32, 33, 34] | 100% | >=100% | — | — |
| | | shall have MBR 10 Mbps | | | | |

1. A method performed by a first node in a communications network for satisfying a first intent set for a system in the communications network, wherein the first intent comprises expectations, each expectation corresponding to a Key Performance Indicator, KPI, target, the method comprising:
i) predicting values of measurable properties that would be observed if a first action were performed in the system, using empirical relationships between actions and the measurable properties;
ii) calculating predicted KPI values that are predicted to be measured in the system if the first action were to be performed, from the predicted values of the measurable properties; and
iii) comparing the predicted KPI values to the KPI targets in the first intent to predict whether performing the first action would lead to the first intent being satisfied for the system.

2. The method as in claim 1 further comprising:
repeating steps i), ii) and iii) for a second action; and
selecting an action from the first action and the second action to perform in the system in order to satisfy the first intent, using the predicted KPI values for the first action and the predicted KPI values for the second action; and
causing the selected action to be performed.

3. The method as in claim 2 wherein causing the selected action to be performed comprises:
performing the selected action; or
sending a message to another node in the communications network to cause the other node to perform the selected action.

4. The method as in claim 2 wherein steps i), ii) and iii) are performed in response to:
determining a difference between measured KPI values in the system and the KPI targets corresponding to the expectations in the first intent; and
raising said difference as a first issue in the system.

5. The method as in claim 4 wherein the first action and the second action are different proposals for resolving the first issue in the system.

6. The method as in claim 4 further comprising:
determining that the predicted KPI values for the first action lead to a conflict with a second intent, if the predicted KPI values for the first action would lead to the second intent not being satisfied; and/or
determining that the predicted KPI values for the first action lead to a conflict between a first expectation and a second expectation in the first intent, if the predicted KPI values would cause a second issue with the second expectation due to the second expectation not being satisfied.

7. The method as in claim 1 wherein the first intent further comprises penalties to be applied if the expectations in the first intent are not satisfied.

8. The method as in claim 7 wherein the penalties quantify an impact of the KPI targets for the expectations not being satisfied.

9. The method as in claim 7 wherein preceding steps i), ii) and iii), the method comprises:
determining a first system penalty, wherein the first system penalty is determined using a penalty formula for aggregating penalties accrued by not meeting one or more of the expectations in the first intent and/or not meeting one or more expectations in other intents set for the system.

10. The method as in claim 9 further comprising: using the outputs of the step of comparing the predicted KPI values to the KPI targets in the first intent, to predict a second system penalty for the system, if the first action were to be performed.

11. The method as in claim 10 comprising:
selecting the first action if the predicted second system penalty is less than or equal to the first system penalty.

12. The method as in claim 10 comprising:
selecting the first action if the predicted second system penalty satisfies a system penalty criterion set in a third intent, wherein the system penalty criterion provides an indication of a manner in which to determine, based on the first system penalty and the second system penalty whether the first action should be selected.

13. The method as in claim 12 wherein the system penalty criterion:
sets a threshold penalty that the system penalty should not exceed; or
indicates that the system penalty should be minimised.

14. The method as in claim 1 wherein the empirical relationships comprise one or more mathematical formulae derived from experimental data, wherein the experimental data comprises:
first test actions and resulting first test values of the measurable properties as performed on the system; and/or
second test actions and resulting second test values of the measurable properties as determined using a digital twin of the system.

15. The method as in claim 14 wherein the one or more mathematical formulae are comprised in a machine learning, ML, model trained using the experimental data.

16. The method as in claim 1 wherein the empirical relationships comprise correlations between actions and the measurable properties, derived using symbolic reasoning.

17. The method as in claim 1 wherein the empirical relationships are expressed as logical inference rules.

18. The method as in claim 1 wherein the step of calculating predicted KPI values that are predicted to be measured in the system if the first action were to be performed, is performed using logical inference rules.

19. The method as in claim 1 wherein the first node is an intent manager in the communications system.

20. A method performed by a second node in a communications network for satisfying a first intent set for a system in the communications network, wherein the first intent comprises expectations, each expectation corresponding to a Key Performance Indicator, KPI, target, the method comprising:
sending a message to a first node in the communications network, wherein the first node acts as an intent manager for the communications network;
wherein the message comprises the first intent for the system and one or more penalties to be applied if the expectations in the first intent are not satisfied.

21.-35. (canceled)
